(19) United States
(12) Patent Application Publication
(10) Pub. No.: US 2016/0032646 A1
(43) Pub. Date: Feb. 4, 2016

(54) RETRACTABLE WALL SYSTEM AND ADAPTOR COMPONENTS

(71) Applicant: Jacob Fleischman, Brooklyn, NY (US)

(72) Inventor: Jacob Fleischman, Brooklyn, NY (US)

(21) Appl. No.: 14/776,737

(22) PCT Filed: Mar. 15, 2014
(86) PCT No.: PCT/US14/30073

§ 371 Date: Sep. 14, 2015

Related U.S. Application Data
(60) Provisional application No. 61/864,563, filed on Aug. 10, 2013.

(30) Foreign Application Priority Data
Mar. 15, 2013 (US) 13/844611

(51) Int. Cl. E06B 9/58; E05D 15/16; E06B 9/68

(52) U.S. Cl. CPC E06B 9/58; E06B 9/68; E05D 15/16

(57) ABSTRACT

The present invention relates to a retractable wall system (12) which may include an elongated member (300). The elongated member may include a front wall (302), a rear wall (303) spaced from the front wall, a bottom wall (304), a first top wall (326a) adjacent the front wall, a second top wall (326b) adjacent the rear wall, and a channel (86) between the first top wall and the second top wall. The channel may comprise a first side wall (86a), a second side wall (86b), a first ledge (86c), and a second ledge (86d). The first and second ledges may define a slot (88) between the first side wall and the second side wall. The elongated member may further comprise a conduit (466) disposed between the front wall (302) and the rear wall (303) that is connected to the channel via the slot.

### CROSS-REFERENCE TO RELATED PATENT APPLICATIONS

This current application claims priority to United States non-provisional patent application entitled “Retractable Wall System” with Ser. No. 13/844,611 filed Mar. 15, 2013, which is incorporated by reference herein in its entirety.

Also, this current application claims priority to United States provisional patent application entitled “Retractable Wall System and Adaptor Components” with Ser. No. 61/864,563 filed Aug. 10, 2013, which is incorporated by reference herein in its entirety.

### FIELD OF THE INVENTION

The present invention generally relates to components for a retractable wall or awning system. More particularly, this invention relates to a track, two flanges, an insert, an entry guide and an end piece for use in a retractable wall system which may be used to divide a room or space, create an acoustic barrier, create a freestanding structure, or provide an awning.

### BACKGROUND OF THE INVENTION

Roller shades may be useful for blocking light and enhancing privacy for windows. Retractable walls may provide the ability to divide a room or provide shade for exterior porches. Still, a need exits for improved retractable wall systems that may span longer distances and utilize heavier fabrics.

### SUMMARY OF THE INVENTION

Hence, the present invention is directed to a track for a retractable wall system which includes an elongated member having a first cross-sectional profile. The first cross-sectional profile may include a front wall, a rear wall spaced from the front wall, and a bottom wall connecting the front wall and the back wall. The first cross-sectional profile may include a first top wall adjacent the front wall, a second top wall adjacent the rear wall, and an open channel disposed between the first top wall and the second top wall. The open channel may include a first side wall connected to the first top wall, a second side wall connected to the second top wall, a first ledge extending from the first side wall into the open channel, and a second ledge extending from the second side wall into the open channel. The first and second ledges may define a slot between the first side wall and the second side wall. The first cross-sectional profile further may include a conduit disposed between the front wall and the rear wall which is connected to the open channel via the slot.

In another aspect of the invention, the first cross-sectional profile further may include a lateral wall that extends from the front wall to the back wall. The conduit may be formed by the first ledge, the second ledge, the first side wall, the second side wall, and the lateral wall. The lateral wall may be connected to the first side wall and the second side wall.

In another aspect of the invention, the first cross-sectional profile may include an interior wall that extends from the front wall to the back wall. The front wall, lateral wall, rear wall and interior wall may define a first interior channel. The front wall, interior wall, rear wall and bottom wall may define a second interior channel. The front wall, the first top wall, the first side wall and the lateral wall may define a third interior channel. And, the rear wall, the second top wall, the second side wall and the lateral wall may define a fourth interior channel.

Another aspect of the invention relates to a retractable wall system which may include a tube having a longitudinal axis, a first track disposed perpendicular to the longitudinal axis, a second track spaced from the first track, and a third track. The third track may include a first traveling guide disposed in the open channel of the first track and a second traveling guide disposed in the open channel of the second track. The retractable wall system further may include a flexible membrane barrier sheet connected to the tube. The sheet may include first, second and third zippered sides. The first zippered side may be disposed in the conduit of the first track and secured to the first traveling guide. The second zippered side may be disposed in the conduit of the second track and secured to the second traveling guide. The third zippered side may be disposed in the conduit of the third track.

In another aspect of the invention, the tube may be a thin wall hollow member. The tube may have a cross-sectional profile that comprises a substantially circular outer wall. The cross-sectional profile further may include a plurality of interior structural members. The plurality of interior structural members may each define a chord within the tube.

In another aspect of the invention, each interior structural member may connect to an adjacent structural member to form an external node which is located about the circumference of the tube. Each interior structural member further may connect to a second adjacent structural member to form another external node that is located about the circumference of the tube. The intersection of two structural members at an external node may form a right angle.

In another aspect of the invention, each interior structural member may intersect another interior structural member to form an internal node. The intersection of two interior structural members at an internal node may form an obtuse angle, which may measure approximately 135 degrees.

### BRIEF DESCRIPTION OF THE DRAWINGS

The accompanying drawings, which are incorporated herein and constitute part of this specification, illustrate an embodiment of the invention, and together with the general description given above and the detailed description given below, serve to explain the features of the invention.

FIG. 1 is a perspective view of a covered patio enclosed on two sides by an embodiment of the retractable wall system of the present invention;

FIG. 2 is an exploded view of an exemplary embodiment of the retractable wall system of the present invention;

FIG. 3 is a partial sectional view of the first retractable wall system along line 3-3 of FIG. 1;

FIG. 4 is a sectional view of the tube of FIG. 3;

FIG. 5 is a sectional view of another embodiment of the tube of FIG. 3;

FIG. 6 is a perspective view of an exploded view of an idler and tube of FIG. 3;

FIG. 7 is a perspective view of the idler and tube of FIG. 6 being assembled;

FIG. 8 is a partial sectional view of the tube, horizontal track, and flexible barrier of FIG. 1;

FIG. 8a is a partial sectional view of FIG. 8;

FIG. 9 is a partial cross-sectional view of the left side track and horizontal track of FIG. 1, taken perpendicular to the longitudinal axis of the left side track;

FIG. 10 is a cross-sectional view of the horizontal track of FIG. 1, taken perpendicular to its longitudinal axis;

FIG. 11 is a cross-sectional view of another embodiment of the horizontal track of FIG. 1, taken perpendicular to its longitudinal axis;

FIG. 12 is a partial sectional view of the head rail of FIG. 1, taken perpendicular to the vertical tracks and from below the tube and motor assembly;

FIG. 13 is a partial sectional view of the head rail, tube and motor assembly of FIG. 1, taken parallel to the vertical tracks;

FIG. 14 is an exploded view of the right side end-cap assembly of the retractable wall system of FIG. 1;

FIG. 15 is a cross-sectional view of the right side track along with a partial cross-sectional view of the horizontal track of FIG. 1;

FIG. 16 is a perspective view of a pair of adjacent tracks and end caps from abutting retractable wall systems of FIG. 1;

FIG. 17 is a detailed view of a pair of tracks aligned to form a corner assembly;

FIG. 17a is a view of the tracks of FIG. 17 fastened together to form a corner assembly;

FIG. 18 is a perspective view of a free standing retracting wall system structure;

FIG. 19 is a plan view of the free standing structure of FIG. 18;

FIG. 20 is a perspective view of an exemplary retractable awning system;

FIG. 21 is a sectional view of the left track of the retractable awning system of FIG. 20;

FIG. 22 is a side view of the retractable awning system of FIG. 20;

FIG. 23 is a sectional view of the front partition of the retractable awning system of FIG. 20;

FIG. 24 is a cross-sectional view of another embodiment of the horizontal track of FIG. 1 taken perpendicular to its longitudinal axis and shown in a locked configuration;

FIG. 25 is a cross-sectional view of the horizontal track of FIG. 24 shown in a released configuration;

FIG. 26 is a perspective view of an embodiment of an adaptor flange of the present invention;

FIG. 27 is a side view of the adaptor flange of FIG. 26;

FIG. 28 is a perspective view of the tube mating portion of the adaptor flange of FIG. 26;

FIG. 29 is a perspective view of the insert mating portion of the adaptor flange of FIG. 26;

FIG. 30 is a perspective view of another embodiment of an adaptor flange of the present invention;

FIG. 30b is a perspective view of the tube mating portion of the adaptor flange of FIG. 30;

FIG. 31 is a front perspective view of an exemplary embodiment of an adaptor insert of the present invention;

FIG. 32 is a rear perspective view of the adaptor insert of FIG. 31;

FIG. 33 is a perspective view of the adaptor flange of FIG. 26 connected to the tube of FIG. 5;

FIG. 34 is a perspective view of exemplary adaptor flange and insert assembly combinations;

FIG. 34B is another perspective view of the exemplary adaptor flange and insert assembly combinations of FIG. 34;

FIG. 35 is a front perspective view of an exemplary embodiment of an end piece of the present invention;

FIG. 36 is a rear perspective view of the end piece of FIG. 35;

FIG. 37 is a bottom perspective view of an exemplary embodiment of an entry guide of the present invention;

FIG. 38 is a top perspective view of the entry guide piece of FIG. 37;

FIG. 39 is a bottom perspective view of another embodiment of an entry guide of the present invention;

FIG. 40 is a top perspective view of the entry guide of FIG. 39;

FIG. 41 is another bottom perspective view of the entry guide of FIG. 39;

FIG. 42 is a front perspective view of another embodiment of an end piece of the present invention;

FIG. 42B is a rear perspective view of the end piece of FIG. 42;

FIG. 43 is another rear perspective view of the end piece of FIG. 42;

FIG. 44 is another rear perspective view of the end piece of FIG. 42;

FIG. 45 is another rear perspective view of the end piece of FIG. 42;

FIG. 46 is a cross-sectional view of the adaptor flange of FIG. 26 along line 46-46 of FIG. 34;

FIG. 47 is a cross-sectional view of the adaptor flange of FIG. 26 along line 47-47 of FIG. 34;

FIG. 48 is a cross-sectional view of the adaptor flange of FIG. 30 along line 48-48 of FIG. 34;

FIG. 49 is a cross-sectional view of the adaptor flange of FIG. 30 along line 49-49 of FIG. 34.

### DETAILED DESCRIPTION OF THE INVENTION

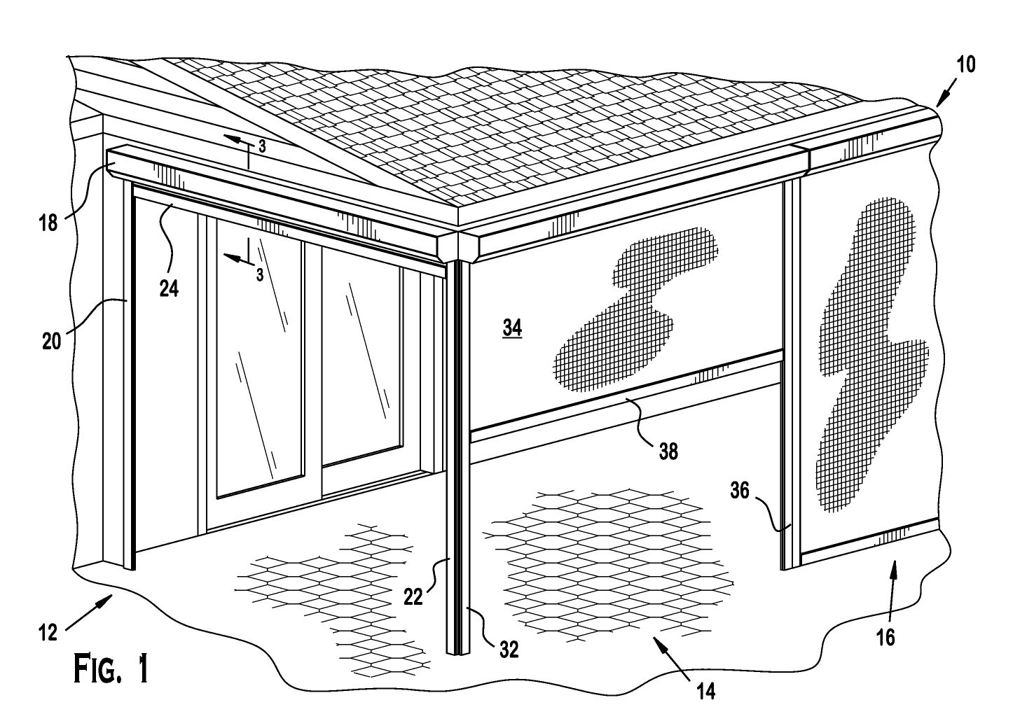

FIG. 1 is a perspective view of a patio enclosure 10 formed by three retractable wall systems 12, 14, 16. The first retractable wall system 12 may be disposed perpendicular to the house and may extend from the side of the house to a first corner of the patio. The second retractable wall system 14 may be disposed perpendicular to the first retractable wall system 12 and may be parallel to the sliding door of the house. The third retractable wall system 16 may be next to the second retractable wall system 14. The first retractable wall system 12 may be disposed in an opening under the roof structure of the house. The first retractable wall system 12 may include a head rail 18, a left side track 20, right side track 22, and a horizontal track 24 disposed between the left side track 20 and the right side track 22. In a preferred embodiment, the left side track 20, the right side track 22 and the horizontal track 24 have the same cross-sectional profile.

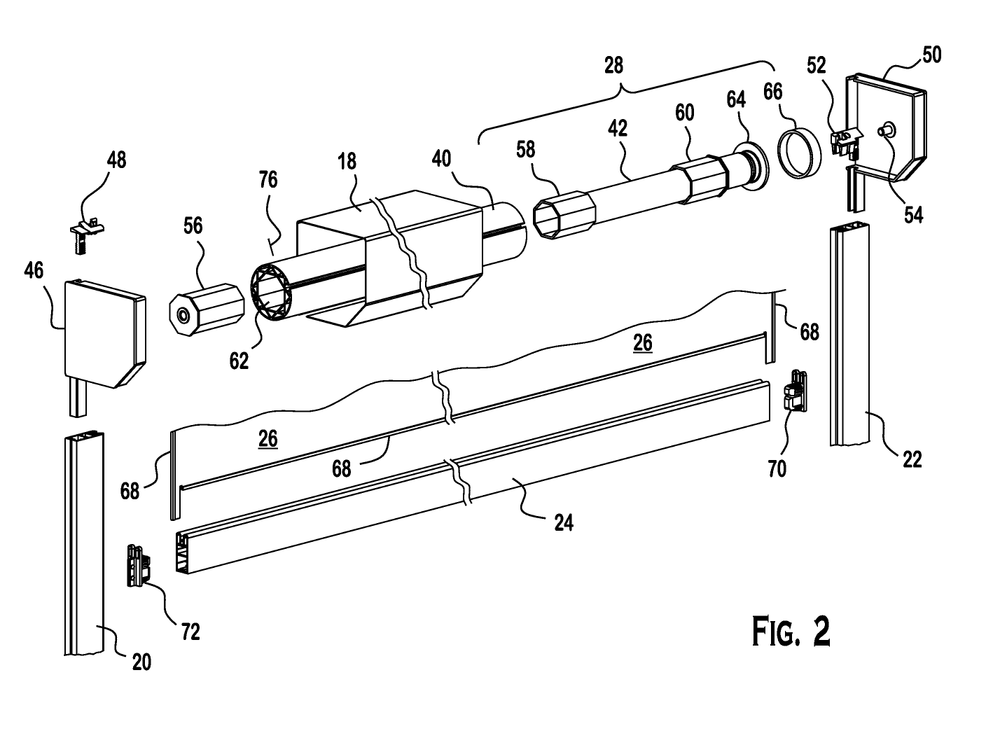

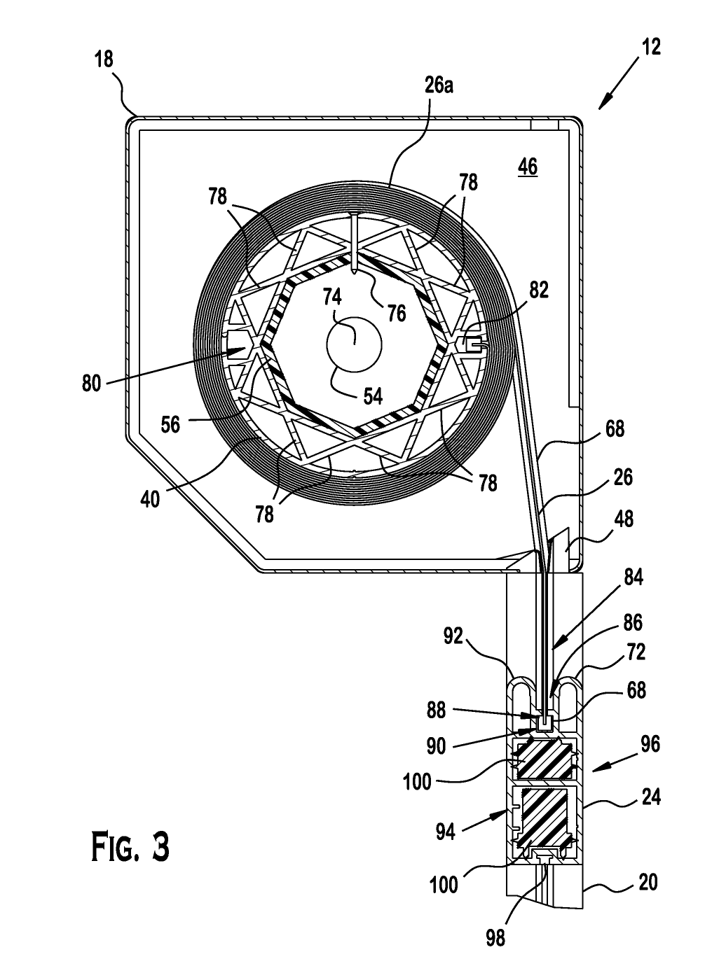

In FIG. 1, the first retractable wall system 12 is in a raised configuration. In the raised configuration the horizontal track 24 abuts the head rail 18. Referring to FIG. 3, the head rail 18 may contain a roll of flexible barrier material 26a, as well as a mechanism (not shown) 28 for raising and lowering the flexible barrier membrane 26. As shown in FIG. 2, the mechanism 28 may include an electrical motor 42, which may be controlled by a wireless remote or switch. Alternatively, the mechanism may include a hand crank or a chain drive with a looped strap for manually raising and lowering the flexible barrier membrane.

Referring to FIG. 1, the left side track 20 of the first retractable wall system 12 may be secured to the building. By contrast, the right side track 22 of the first retractable wall system 12 may be connected to the left side track 32 of the second retractable wall system 14 at a 90 degree angle to form a corner assembly. The second retractable wall system 12 is shown in a partially lowered configuration. A flexible barrier material 34 may be disposed between the left side track 32, right side track 36 and horizontal track 38 of the second retractable wall system 14. The flexible barrier material 34 may extend from inside each of these three tracks 32, 36, 38 to create a wall.

As shown in FIG. 3, the flexible barrier material 26 may be disposed on a tube 40 in the head rail. The flexible barrier material 26 may be rolled onto the tube 40 and unwound from the tube as the horizontal track 24 is lowered. Referring to FIG. 1, the third retractable wall system 16 may be disposed parallel to the second retractable wall system 14. The right side track of the second retractable wall system 14 and the left side track of the third retractable wall system 16 may be secured together or connected to a secondary structural member (e.g., a post or stud). The third retractable wall system 16 is shown in the lowered configuration.

FIG. 2 shows an exploded view of the first retractable wall system 12. The retractable wall system 12 may include a left side track 20, a right side track 22, and a horizontal track (or weight bar) 24 extending between the left side track and the right side track. Additionally, the retractable wall system 12 may include a left side end-cap 46 which is secured into the left side track 20 and a left side feeder-clip 48 that is positioned in the left side end-cap 46. Similarly, the retractable wall system 12 includes a right side end-cap which may be secured into the right side track 22, as well as a right side feeder-clip 52 that may be disposed in the right side end-cap 50. When the left side end-cap 46 is fully seated in the left side track 20 the left side feeder-clip 48 interlocks with features of the left side track 20 cross sectional profile to further secure the left end-cap to the left side track. Similarly, when the right side end-cap 50 is fully seated in the right side track 22, the right side feeder-clip 52 interlocks with features of the right side track 22 cross-sectional profile to further secure the right end-cap to the right side track. Each end-cap 46, 50 further may include a cylindrical stub 54 in the end-cap wall. The cylindrical stub 54 may receive the tube assembly and serve as axis of rotation for the tube 40.

The roller tube assembly may include an idler 56, a tube 40 having a central axis, and a mechanism 28 for rotating the tube 40 about the central axis of the tube. In a preferred embodiment, the mechanism 28 may include a motor 42 that is partially installed with the tube 40. The motor 42 may include a built in radio control receiver that provides a user the capability to operate the motor with a remote control. For example, the motor may be a Somfy RTS motor.

In FIG. 2, the mechanism 28 for rotating the tube includes a motor 42 with a remote control. The motor, which may be slidably received within the tube 40, may include a drive 58 and a crown 60. The drive 58 and crown 60 may be external features of the motor which interlock with an interior surface 62 of the tube so as to provide a mechanism for transferring rotational movement from the motor or the tube. The motor 42 further may include a drive wheel 64 at one end. The drive wheel 64 may be configured and dimensioned to be fixedly received within a motor bracket 66. The motor bracket 66 may be secured to one end-cap 50. The tube assembly 28 further may include a sheet of flexible material 26. The sheet of flexible material 26 may include a zipper border 68 on at least three sides. The sheet of flexible material 26 may be cut to be received in a pair of traveling guide pieces 70, 72 that are adapted to be received in the horizontal track 24.

FIG. 3 shows a cross-section of the retractable wall system 12 taken perpendicular to the central axis 74 of the tube 40. The tube 40 may be mounted on the cylindrical stub 54 of the left end-cap 46. The tube 40 may be secured to the idler 54 with a fastener. Inside the tube 40 are interior wall segments 78, which form a mating structure for the motor drive and crown. The interior wall segments 78 may be arranged to provide structural rigidity to the tube. In particular, the interior wall segments may span the internal space of the tube 40 so as to provide a three dimensional truss or space frame. Additionally, the tube may include a fabric pocket receiving channel 80 and a fabric zipper receiving channel 82, which may be used to connect the flexible barrier material 26 to the tube 40. Wrapped around the tube 40 is a sheet of flexible barrier material 26a, which may include a heat bonded zipper edge 68 on the left side and the bottom side of the sheet.

The end-cap 46 may be situated within the left side track 20. The left side of the flexible barrier material sheet 26 may be fed through the left side feeder-clip 48 into a rigid receiving channel 84a in the left side track 20. The bottom side of the flexible barrier material 26 sheet may be received within the horizontal track 24. The cross-sectional profile of the left side track 20 and horizontal track 24 may be the same. Accordingly, the flexible barrier material 26 may be secured to the horizontal track 24 through a rigid receiving channel 86 in the horizontal track 24. A slot 88 may connect the rigid receiving channel 86 to an internal anchoring cavity 90 that is configured and dimensioned to receive the bonded zipper edge 68 of the sheet. The rigid receiving channel 86 may be disposed between a pair of arcuate walls 92. The internal anchoring cavity 90 may be disposed adjacent to the rigid receiving channel 86.

The horizontal track 24 further may include a primary accessory receiving channel 94, a secondary accessory receiving channel 96, and a tertiary accessory receiving channel 98. Weights, for example, steel bars 100 may be placed with the primary accessory receiving channel 94 or the secondary accessory receiving channel 96 of the horizontal track 24 to facilitate lowering of the flexible material barrier 26. In another example, sound dampening material may be inserted in these spaces to increase the sound insulating properties of the retractable wall system. An elastomeric end cap, flexible seal, or brush may be inserted in the tertiary accessory receiving channel 98 to provide an improved connection with the ground surface for purposes such as, without limitation, increasing wall stability, slip resistance, draft prevention, or sound dampening.

FIG. 4 shows a cross section of a preferred embodiment of the tube 40. Generally, the tube 40 may be a thin-wall hollow member. The outer surface 102 of the tube may be substantially circular, and the interior space of the tube may include a series of interior wall segments (or structural members) 78, which may reinforce the tube against bending moments that may be generated from the weight of flexible barrier material on the tube when the tube is positioned between the end caps. Each structural member 78 may form a cord within the tube 40. Each structural member 78 may connect to an adjacent structural member 78 to form an external node 104, which is located about the circumference of the tube. Additionally, each structural member 78 may intersect two other structural members 78 to form a pair of internal nodes 106. The intersection of a pair of structural members 78 at an external node 104 forms a right angle. The intersection of a pair of structural members 78 at an internal node forms an obtuse angle of approximately 135 degrees. The space between an internal node 106 and outer wall 108 of the tube may be used to house the pocket receiving channel 80 and the zipper receiving channel 82. Additionally, a fastener alignment groove 110 may be disposed above one or more internal nodes on the outer surface 102 of the tube. The interior surface 62 of the tube may form an eight sided shape for receiving a motor (with a mating drive and crown) or an octagonal tube for non-motorized applications (e.g., 40 mm, 60 mm, or 80 mm tubes).

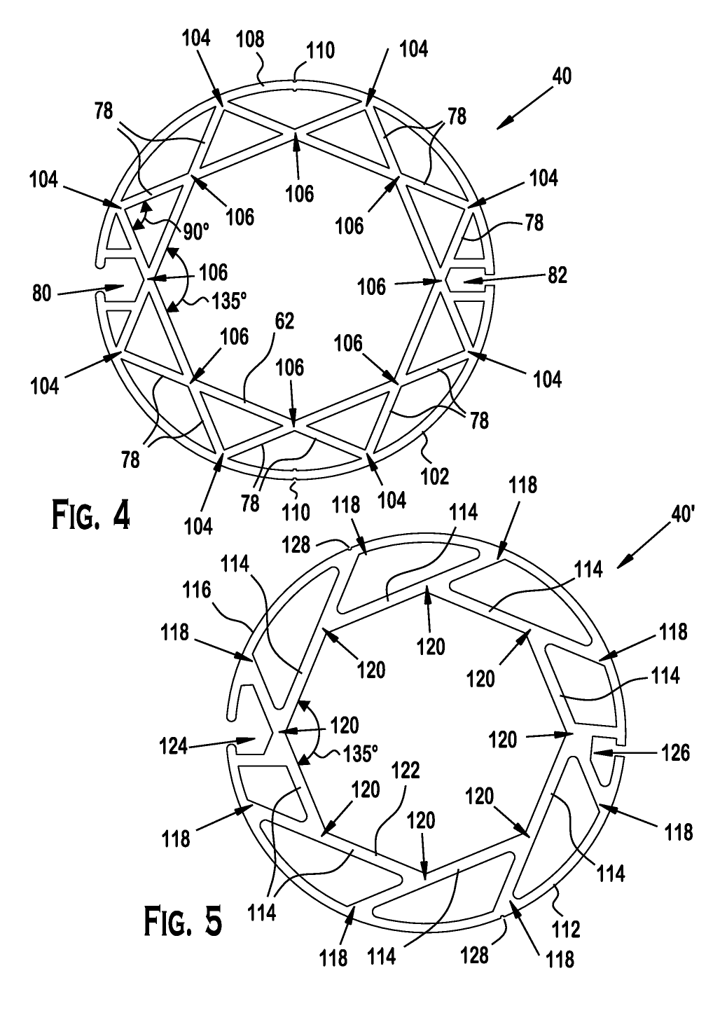

FIG. 5 shows the cross-section of another embodiment of the tube 40′. In this embodiment, the outer surface 112 of the tube 40′ is substantially circular and the interior space includes a series of structural members 114 that reinforce the tube 40′ from bending moments as in the previous embodiment. In contrast to the tube of FIG. 4, however, each structural member 114 connects to the outer wall 116 of the tube at one location (or external node) 118. Additionally, the opposite end of each structural member 114 may connect to an adjacent structural member 114 to form an internal node 120. The interior surface 122 of the tube 40′ may form an eight sided shape for receiving a motor (with a mating drive and crown) or an octagonal tube for non-motorized applications (e.g., 40 mm, 60 mm, or 80 mm tubes). In this embodiment, the tube 40′ also may include a pocket receiving channel 124, a zipper receiving channel 126, and two fastener alignment grooves 128.

Referring to FIGS. 4 and 5, the tube 40, 40′ may have an outer diameter of approximately 1.0 inches to approximately 6.0 inches, but other dimensions may be used where appropriate for the application. In an exemplary embodiment, the tube 40, 40′ may have an outer diameter of approximately 3.5 inches and an interior surface 62, 122 which is configured and dimensioned to receive a 60 mm octagonal tube. Additionally, the tubes 40, 40′ may range from approximately one foot long to approximately 30 feet in length. The tube 40, 40′ may be formed from aluminum or an aluminum alloy (e.g., 6061 aluminum alloy (International Alloy Designation System)), however, other suitable metals, alloys or materials may be used to form the tube provided the material has sufficient strength. For example, the tube 40, 40′ may be formed from a carbon graphite reinforced polymer material. Preferably, the tube 40, 40′ may be formed by materials having a high strength to weight ratio and the ability to be manufactured using extrusion technologies.

Referring to FIG. 4, the flexible barrier material 26 may be secured to the tube 40 by a pocket of flexible barrier material 130 and rod 132 inserted within the pocket receiving channel 80. In another alternative, the flexible barrier material 26 may be attached to a zipper 68 that is inserted into the zipper receiving channel 82. Generally, the flexible barrier material 26 may range from approximately 1/32 of an inch in thickness to approximately ½ inch in thickness. The flexible barrier material 26 may be formed, without limitation, from natural fibers, leather, PVC, polyester, or acrylic materials. Preferably, the flexible barrier material 26 may range from approximately 7 ounces to 60 ounces in weight. In one example, the flexible barrier material 26 may be constructed from a 20 ounce vinyl fabric. In another example, the flexible barrier material 26 may be constructed from a vinyl fabric that is capable of receiving a print design. In another example, the flexible barrier material 26 may be constructed from a screen, a transparent material or a natural fabric.

The flexible barrier material 26 may be a single layer of material or a multilayer material formed from two or more layers of material. For example, the flexible barrier material 26 may be formed from three layers: a middle layer having enhanced sound dampening properties (e.g., mass loaded vinyl, Acoustiblok®) and two outer fabric layers (e.g., cotton, polyester, rayon, vinyl, wall paper, or wall covering material) to create an acoustic barrier. In another example, the flexible barrier material 26 may be formed from clear plastic sound blocking material. Preferably, a flexible barrier material with enhanced sound dampening properties may have a STC (Sound Transmission Class) rating of 26 or greater.

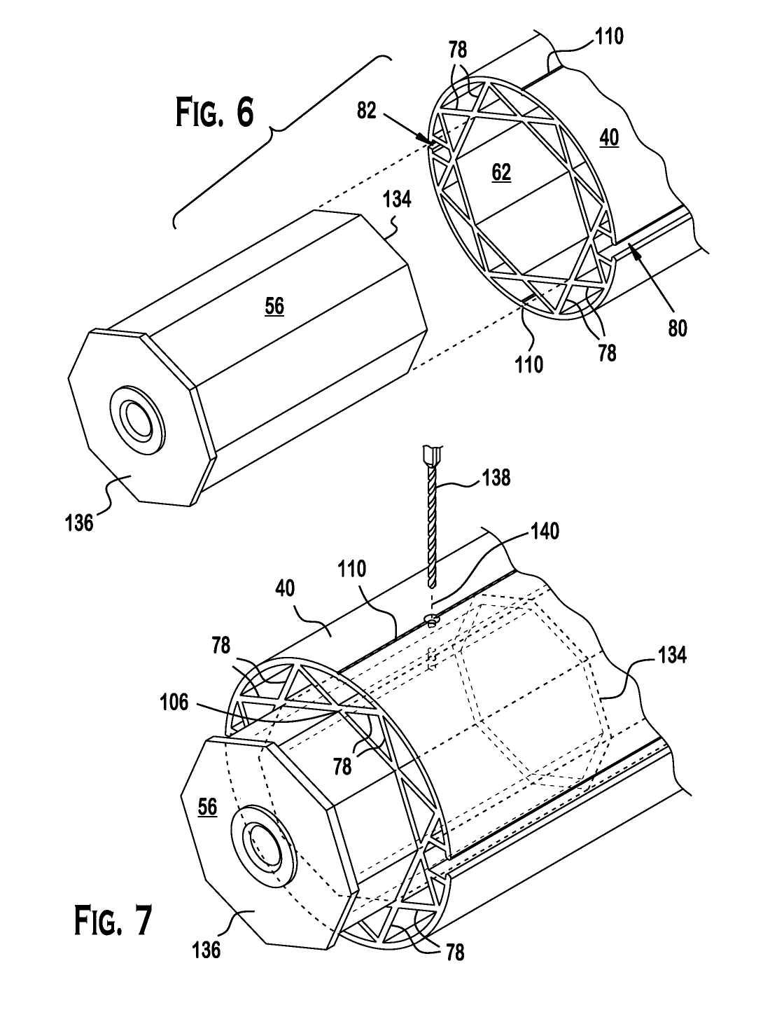

FIG. 6 shows an exploded view of the idler 56 and the tube 40 of FIG. 4. One end 134 of the idler 56 may be inserted into the tube 40. The opposite end 136 of the idler 56 may be mounted on the end-cap cylindrical stub 54 (not shown) to form an axis of rotation. The tube 40 may include one or more fastener alignment grooves 110. As shown in FIG. 7, a drill (or fastener) 138 may be placed in a fastener alignment groove 110 to create a fastener alignment path 140 for securing the idler 56 to the tube 40. The fastener alignment groove 110 may be located above an internal node 106 of the tube. Placement of a fastener alignment groove 110 above an internal node 106 provides a mechanism for promoting a repeatable, quick, and straightforward method of securing the idler 56 and the tube 40 with a fastener 138. More particularly, the fastener path 140 connects the fastener alignment groove 110 and the internal node 106 of the tube. A fastener that is aligned in this manner may be expected to penetrate the tube 40 beneath the fastener alignment groove 110 and be guided by adjacent internal structural members 78 to a position above the internal node 106. This fastener path may provide a secure connection because the fastener may be driven perpendicular to the outer surface of the tube wall and through the internal node 106 before advancing into and securing the idler 56.

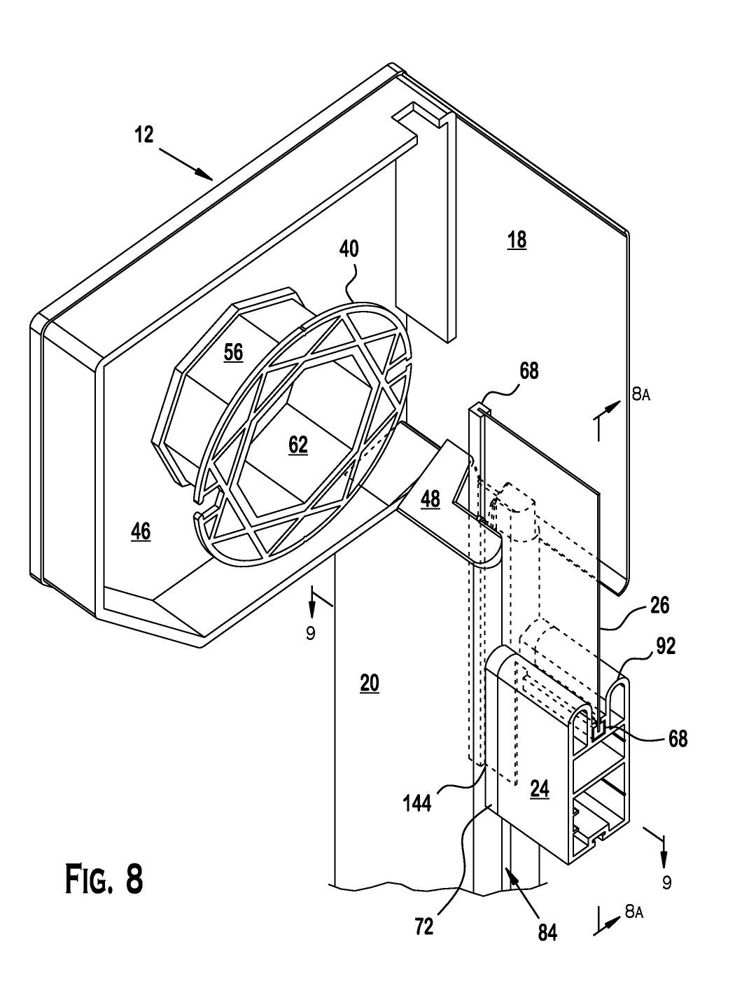

FIG. 8 shows the left side of the flexible barrier member 26 disposed in the left side feeder-clip 48 and left side track 20 of the retractable wall system 12. Also, the bottom of the flexible membrane barrier 26 is shown locked into the horizontal track 24. As shown in FIG. 8A, the left side of the flexible material barrier is fully seated within the traveling guide pin 72. The full length square cut double pin construction 142 provides rigid reinforcement of the flexible barrier material 26 at a leading edge 144 of the sheet. As the leading edge of the sheet 144 may be subject to compressive and sheering forces as the barrier is lowered, the traveling guide pin 72 may prevent the flexible barrier material 26 from wearing, tearing, bunching or binding in the vertical track 20 when the horizontal track 24 is lowered or raised.

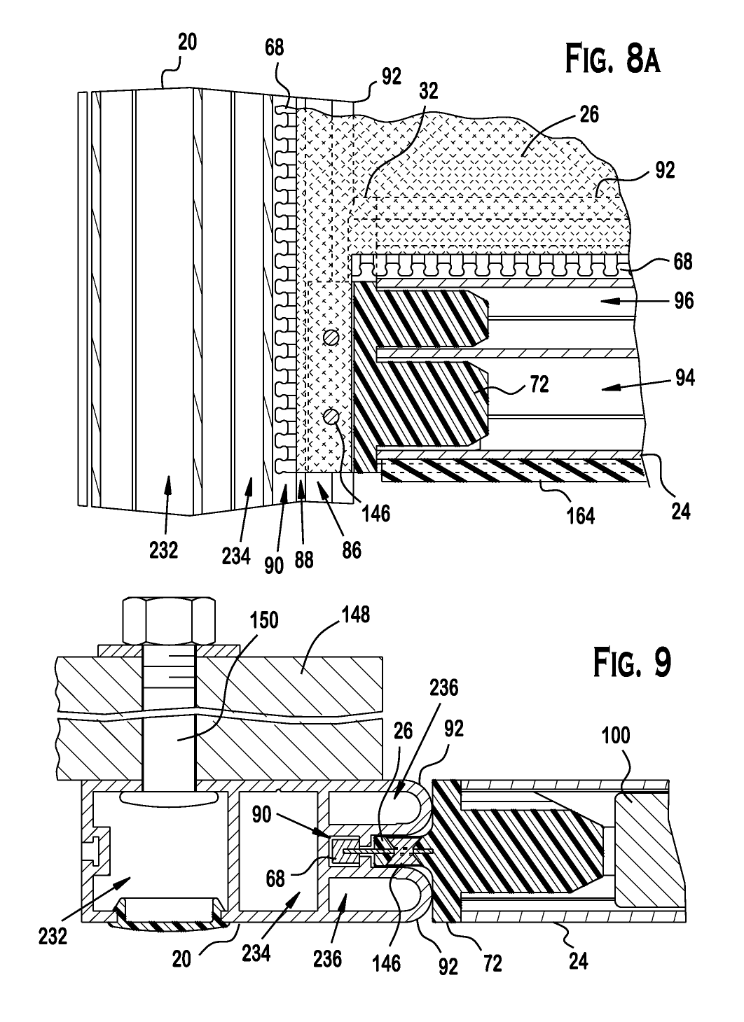

Moreover, as shown in FIG. 9, the traveling guide pin 72 may be configured and dimensioned to be slidably received within the rigid receiving channel 84 of the vertical track 20. As the fasteners, which secure the flexible membrane barrier 26 to the traveling guide pin 72 are located with the rigid receiving channel 84, they may be recessed or flush with the exterior surfaces of the traveling guide pin 72. The zipper portion 68 of the flexible membrane barrier 26, when disposed in the internal anchoring cavity 90, pulls the traveling guide pin 72 into the rigid receiving channel 84 of the vertical track 20. In this manner, the horizontal track 24 and the sides of the flexible membrane barrier 26 may be securely positioned within the left side track 20 and the right side track 22.

The reinforcement of the flexible barrier material 26 and tension across the vertical tracks 20, 22 may increase the structural integrity of retractable wall system 12, provide for more reliable operation of the system, and reduce mechanical fatigue of the zipper-material interface. Also, the generally uniform tension across the flexible membrane barrier 26 may increase the aesthetic appeal of the retractable wall system 12 by enhancing a uniform appearance of the flexible barrier material across the structure. Moreover, in outdoor applications, this construction may prevent drafts. In sound barrier applications, this construction may promote the deployment of a continuous sound dampening barrier and prevent fugitive sound emissions from passing individual barrier elements to reduce the effective sound dampening properties of the retractable wall system. Sound dampening material may be placed in the primary accessory receiving channel 232, the secondary receiving channel 234, and the arcuate receiving channels 236 as well.

The vertical track 20 of the retractable wall system may be secured to a structural member such as a stud or post. A pilot hole may be drilled and then a larger access hole placed in the track 20 to allow a fastener 150 to be advanced though the opposite side the track and into external structural framing 148 to securely attach the vertical track 20 to structural framing of an adjacent wall or post.

Referring to FIGS. 10 and 15, the horizontal track 24, the left side track 20, and the right side track 22 may share a single cross-sectional profile 152. In FIG. 10, the track profile 152 is shown in use as a horizontal track 24. In this configuration, the primary accessory receiving channel 94 may accommodate a weight bar 100, which may be a ½ inch by ¾ inch steel bar. The weight bar 100 may be positioned within the primary accessory receiving channel 94 by the end-cap stem blocking member 154, the upper rail guide 156, and the lower rail guide 158.

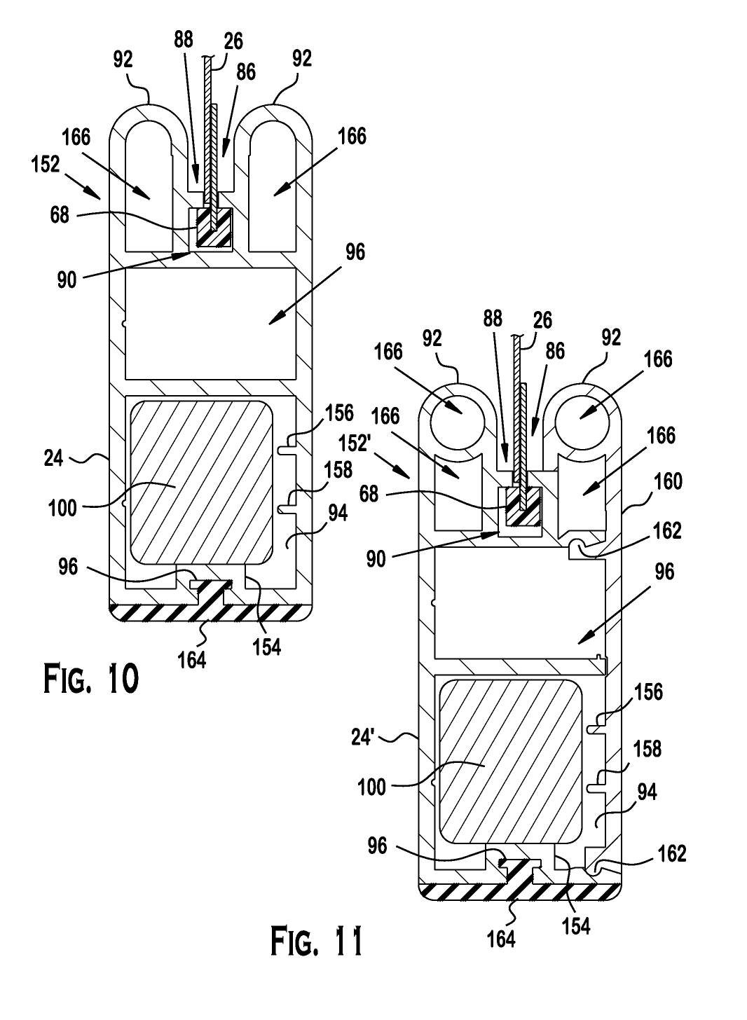

In FIG. 11, the cross-sectional profile of the track 152′ is substantially the same as in FIG. 10, but a front portion 160 of the track 24′ is removable and forms a cover. The removable portion 160 may be secured to the track 24′ with snap fittings 162. This feature allows weight bars 100 to be installed in the horizontal track 24′ after the retractable wall structure 12 has been erected. This may improve constructability of the system and enhance the safety of workers because handling the horizontal track with preloaded weight bars 100 is significantly heavier than handling an empty horizontal track.

FIGS. 10 and 11 show an elastomeric cap 164 disposed in the tertiary accessory channel 96. Arcuate, upper receiving channels 166, as well as the primary and secondary accessory receiving channels 94, 96 may receive sound damping materials to enhance the sound dampening effect of the retractable wall system.

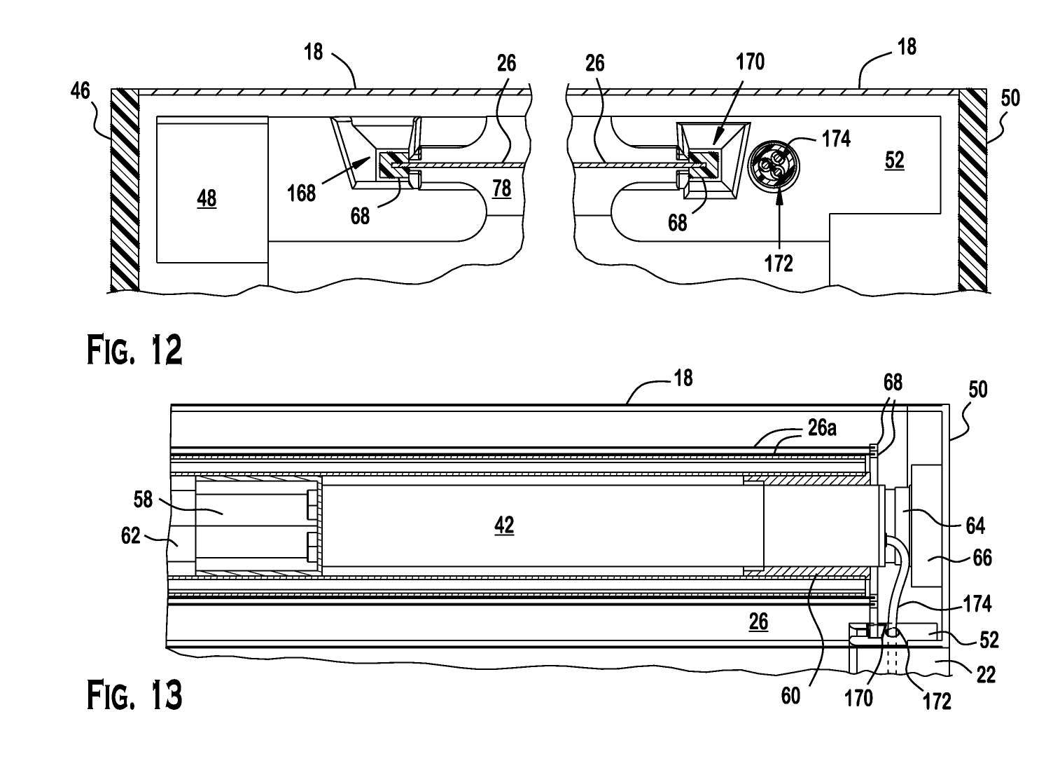

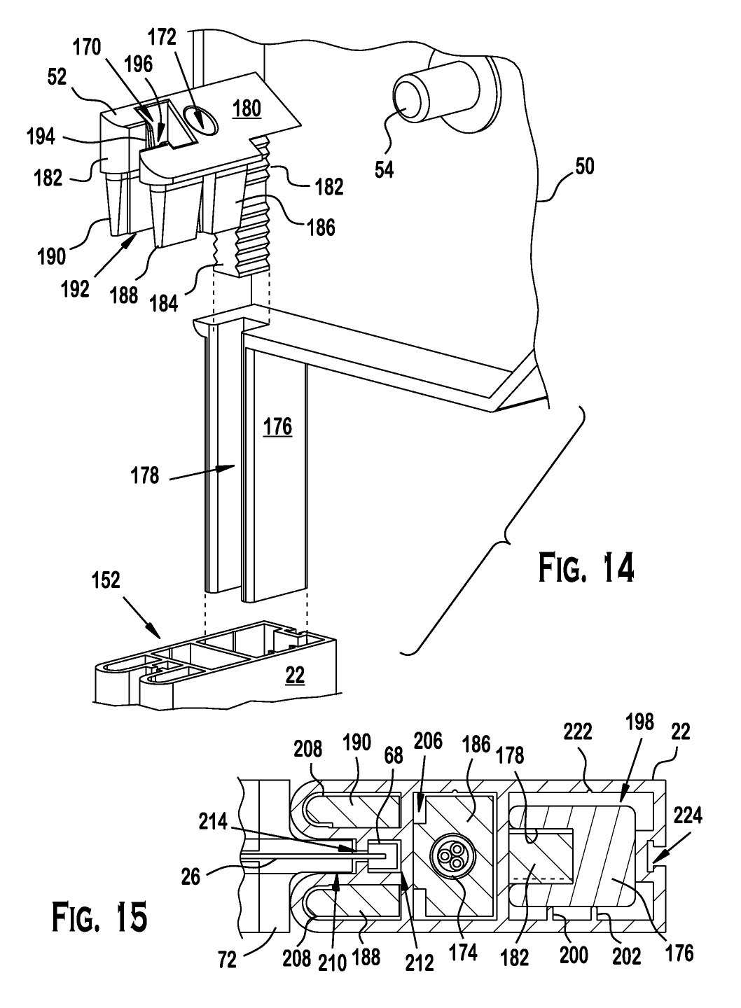

FIG. 12 shows the left feeder-clip 48 and its tapered guide hole 168. The tapered guide hole 168 receives the zippered edge 68 of the flexible barrier material 26 as it spools off the tube (not shown). Similarly, FIGS. 12 and 13 show the right feeder-clip 52 and its tapered guide hole 170, which receives the zippered edge 68 of the other side of the flexible barrier material 26. The right feeder clip 52 may further include a circular passage 172 for receiving a power cord 174 from the motor 42.

Referring to FIG. 14, the right end-cap 50 may include a stem 176 having a rectangular channel 178. The right side feeder-clip (or entry guide) 52 may include a beveled top surface 180, a central base portion 182, and four plugs 184, 186, 187, 188. One end of the feeder-clip 52 may include an elongated and corrugated plug 184. Next to the elongated and corrugated plug 184 and disposed in the middle of the feeder-clip 52 may be a second plug 186. The second plug 186 may be wider and shorter than the elongated corrugated plug 182. Also, a pair of contra-lateral plugs 188, 190 may be disposed on the other side of the second plug 186.

The right feeder-clip 52 may include a circular passage 172 that extends from the beveled top surface 180 through the second plug 186. The passage 172 may be configured and dimensioned to receive an electrical cable for the motor. Additionally, the beveled top surface 180 may include a first tapered rectangular passage 170 which extends through the feeder-clip 52. A second rectangular passage 192 may extend from the beveled top surface 180 through the feeder-clip 52 between the contra-lateral plugs 188, 190. The first rectangular passage 170 and the second rectangular passage 192 may be separated by a thin wall 194. The thin wall 194 may include a tapered slit 176 which extends from the top of the thin wall to the bottom of the thin wall.

As shown in FIG. 15 the right feeder-clip 52 may be inserted into the rectangular channel 178 of the end-cap 50. The stem 176 of the end-cap may be seated within the primary accessory channel 198 and may be positioned in the primary accessory channel 198 by the upper guide rail 200, the lower guide rail 202, and the end-cap stem blocking member 204. The second plug 186 of the feeder-clip 52 may be received in the secondary accessory receiving channel 206. The secondary accessory receiving channel 206 may be used to accommodate an electrical cable 174 that extends from the motor 42 to an electrical outlet outside the track. The pair of contra-lateral plugs 188, 190 may be disposed in the opposing arcuate cavities 208 at the front of the track. The traveling guide member 72 may be disposed in the rectangular receiving channel 210 of the track and the zippered end 68 of the flexible membrane barrier 26 may be disposed in the internal anchoring cavity 212. The material connecting the zipper 68 and the flexible membrane barrier 26 may be disposed in the slot 214 between the rectangular receiving channel 210 and the internal anchoring cavity 212.

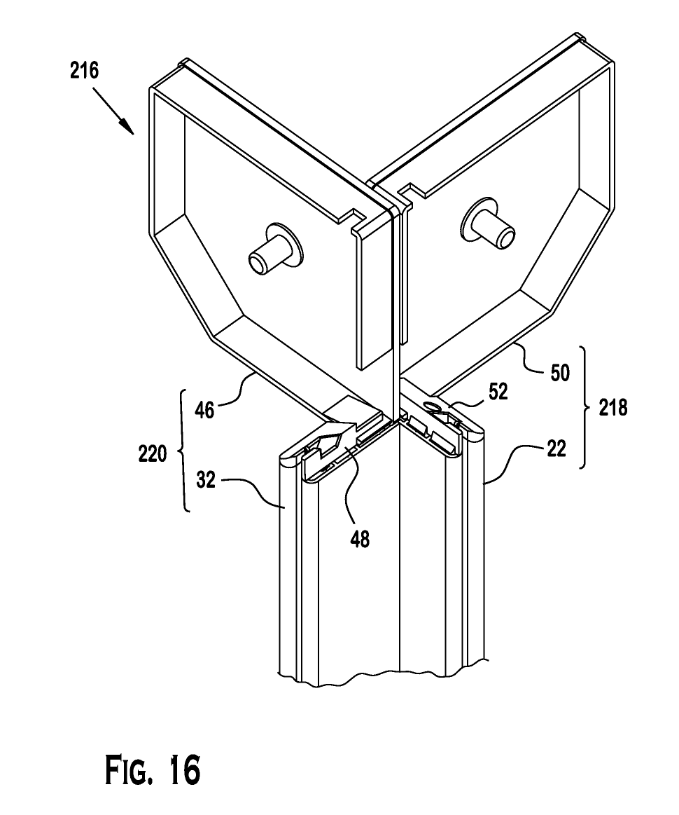

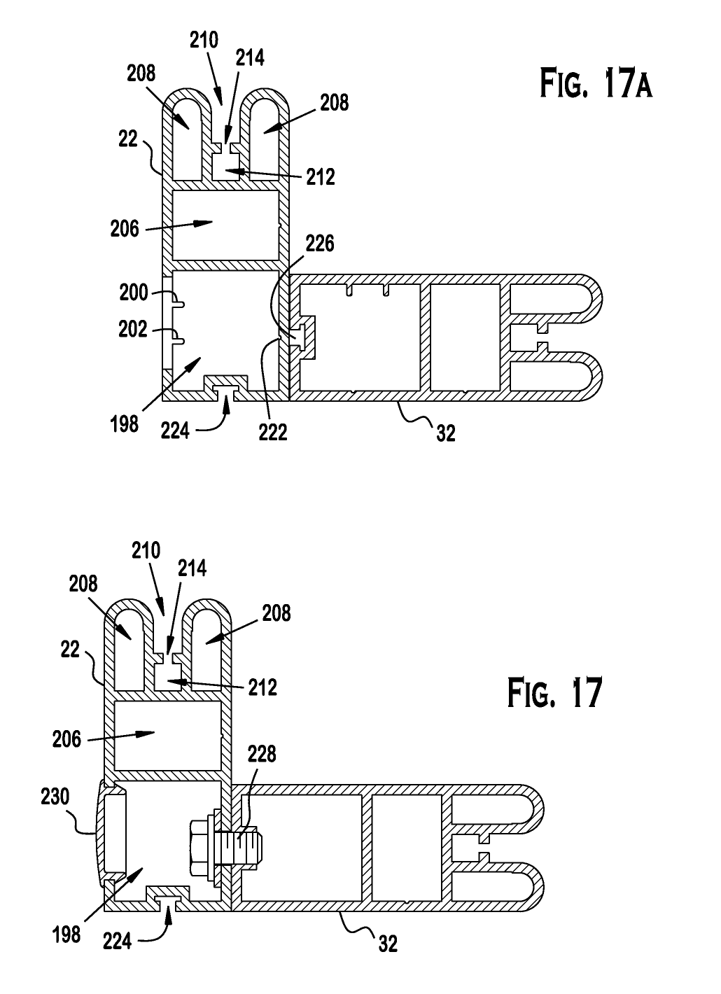

FIG. 16 shows an exemplary corner assembly 216 formed from a first end-cap and track 218 and a second end-cap and track 220. The first end-cap and track 218 and the second end-cap and track 220 may be disposed at an approximately 90 degree angle. The corner assembly 216 may be used to construct adjacent retractable wall systems, as shown in FIG. 1.

FIG. 17 shows an exemplary alignment of two tracks 22, 20 which may be used to construct a corner assembly 216. In the track alignment, the alignment groove 222 in the primary accessory receiving channel 198 may be disposed opposite the tertiary accessory groove 226 of the adjacent track. FIG. 17a shows how the two tracks 20, 32 may be securely fastened to each other. In a preferred method, a guide hole may be drilled between the upper and lower guide rails 200, 202 in the primary accessory receiving channel 198. The guide hole may be enlarged to an entry hole in order to provide access to the interior of the primary accessory receiving channel. A fastener 228 may be positioned in the alignment groove 222 (FIG. 17) and advanced into the tertiary accessory groove 226 (FIG. 17) of the adjacent track. The enlarged hole may be covered with a plastic cap 230.

Referring to FIG. 18, four corner assemblies 216 may be used to construct a free standing structure. The free standing structure may be formed from four (or more) retractable wall systems 240a, 240b, 240c, 240d, 240e. Two retractable wall systems 240c, 240d may be joined together to form one side of the structure. One of the retractable wall systems 240c may be used as a door for the structure.

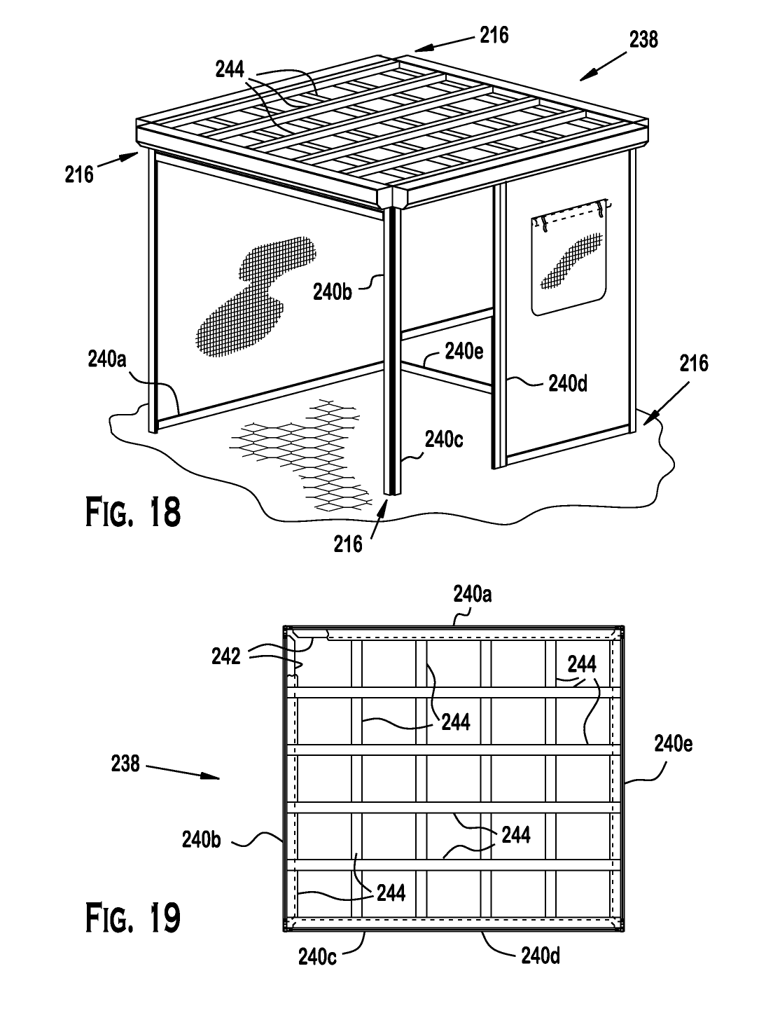

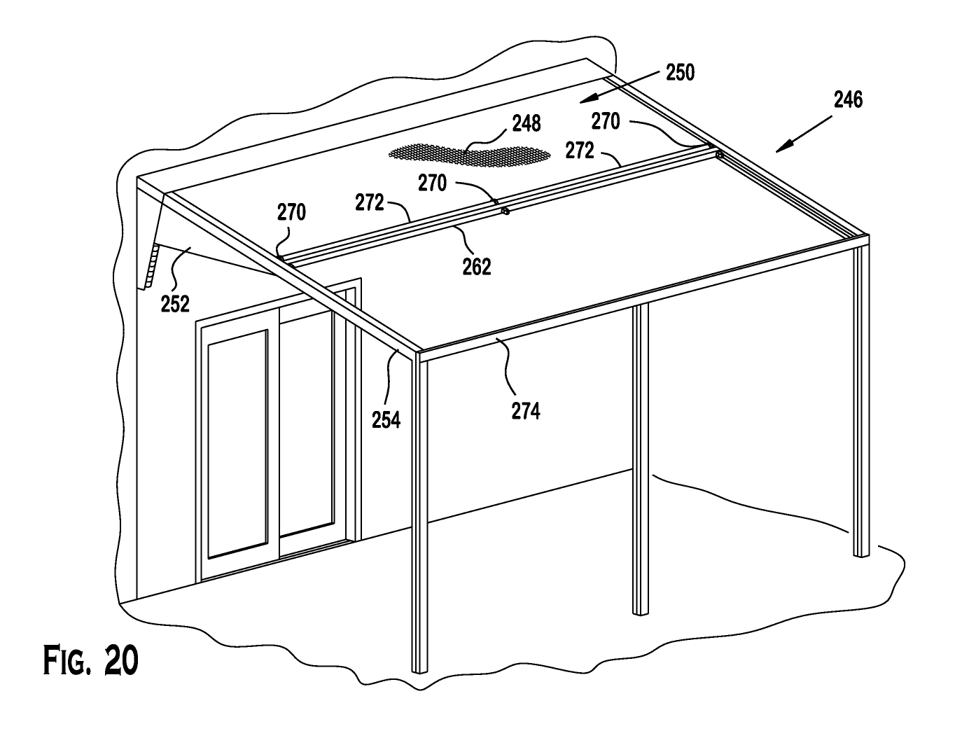

Referring to FIG. 19, a short ledge 242 may extend from the lower portion of the head rail into the enclosed space. The short ledges 242 of opposing retractable wall systems 240b, 240e may be used to support beams 244, which may form a cover for the structure 238. The beams may be used to form a continuous cover or a lattice cover. For example, wood boards (e.g., 1″×2″ or 2″×4″ boards) may be supported by the head rail ledges to form a lattice cover, which may allow the structure to be used as a temporary booth (or Sukkah) that is constructed for use during the Jewish festival of Sukkot.

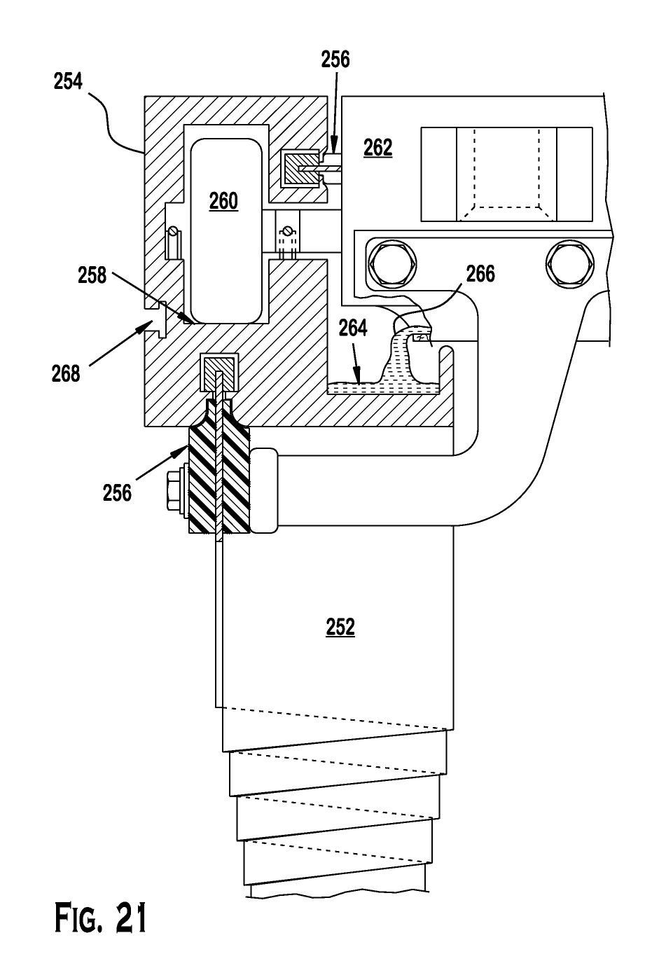

Referring to FIGS. 20, the retractable wall system may be adapted for use as an awning 246. A webbing material may 248 be molded to the flexible membrane barrier 250 that forms the awning cover in order to make the canopy stronger while maintaining light weight. The awning 246 may include a side pennant 252. As shown, in FIG. 21, the side track of the retractable wall system may be modified such that the side frame 254 incorporates a reinforced flexible membrane barrier connection 256 to provide a taunt but retractable ceiling canopy. The side frame 254 may include a roller track 258 for a wheel 260 which is connected to the front crossbar 262. Also, the side frame 254 may include a gutter 264 for collecting and transporting rain water 266. An exterior groove 268 on the side frame may be used to house a sealant for sealing the frame to a structure or an abutting awning frame.

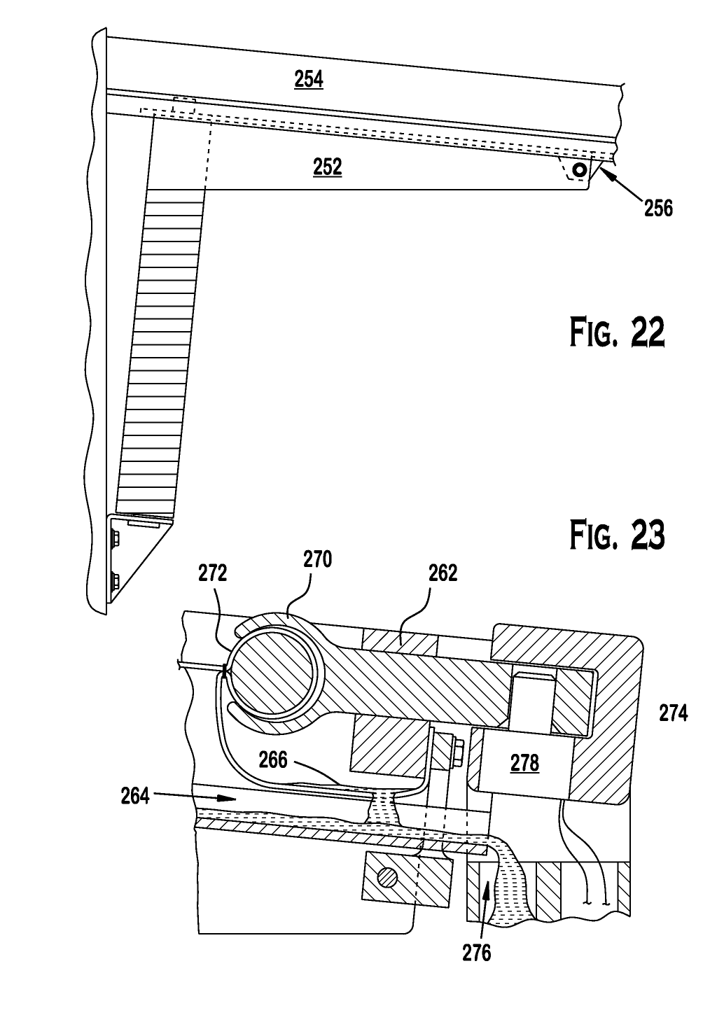

As depicted in FIGS. 21-23, a reinforced flexible membrane barrier connection 256 may be used to deploy a side pennant 252 with the ceiling canopy. Referring to FIG. 23, the front cross bar 262 may support a bracket 270 that holds a loop of canopy material 272 to form a pocket to collect and direct rain water 266 to the gutter 264. The front partition 274 of the awning structure 246 may include a channel 276 for receiving water from the gutter. In another embodiment, the gutter and wheel track may include the same structure. The front partition 274 further may include a solenoid 278 that may be used to lock the awning in the deployed configuration. Additionally, a brake (not shown) may be available on the motor end and the non-motor end of the awning spool. The retractable wall system may be constructed from materials selected to better withstand changes in temperature, corrosion, or degradation from ultraviolet light.

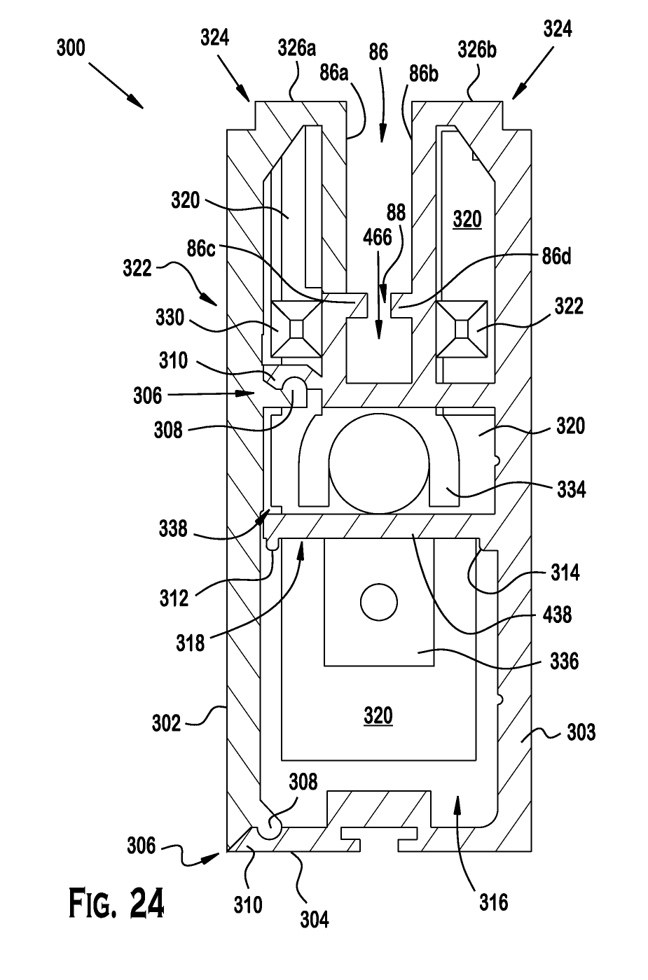

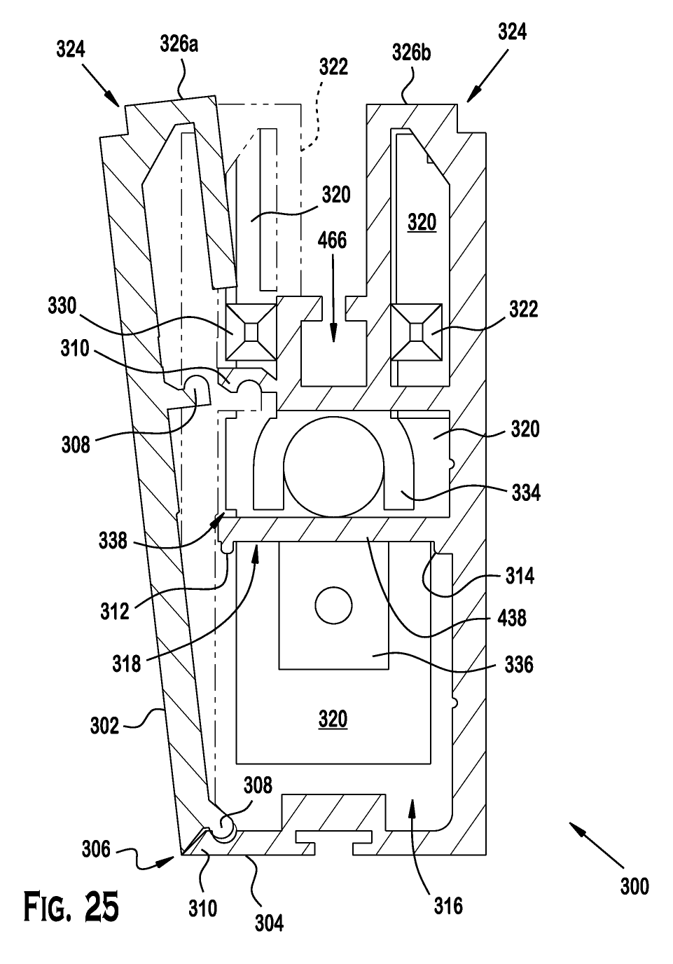

Referring to FIG. 24, the cross-sectional profile of the track 300 is generally the same as in FIG. 10, but a first portion 302 of the track 300 may be removable, and may form a cover. The removable portion (e.g., Part 1) 302 may be secured to a receiving (or base) portion 304 (e.g., Part 2) with one or more snap fitting(s) 306. In an exemplary embodiment, the snap fitting 306 may be a mechanical joint system where part-to-part attachment is accomplished with locating and locking features that are homogenous with one or the other of the components being joined. Joining may require the (flexible) locking features to move aside for engagement with the mating part, followed by return of the locking feature toward its original position to accomplish the interference required to latch the components together. Locator features may be inflexible, providing strength and stability in the attachment. Each snap fitting (or snap fit locking pair) 306 may be formed from a hook 308 and an undercut 310. In FIGS. 24 and 25, the undercut 310 may be a cantilevered lug; and the hook 308 may be a lip or projection that snaps into the undercut. Assembly of the snap fitting 306 may require temporary deformation of one or both pieces, but the parts may return to an unstressed state in the final assembled position. Additionally, the retaining force of a cantilevered lug may be a function of the bending stiffness of the cantilevered lug. Thus, the lugs may be loaded partially to achieve a tight assembly. Although the retention of each snap fit locking pair 306 may be releasable, the retention may be permanent in certain applications.

As shown in FIG. 24 and FIG. 25, a retention wall 312 and a guide wall 314 may be configured and dimensioned to retain an accessory in the primary receiving channel 316. For example, the retention wall 312 and guide wall 314 may form parallel sides of a channel 318 that may hold the accessory, for example, an entry guide piece 320 within the primary receiving channel 318 of the track when the cover 302 is removed from the receiving portion 304. In FIG. 24, the track is shown in an assembled (or locked) configuration 322. During installation the recessed, square profile 324 of the upper contour of the track 326 may allow the track to integrate smoothly with drywall and other construction materials without the appearance of cracks or spaces between the finished drywall and track.

Referring to FIG. 25, the track 300 may have a released configuration 328 in which the cover 302 is separated from the other part (Part 2) 304. Thus, the cover 302 may be attached to receiving portion 304, after the receiving portion 304 has been connected to other structural members of the retractable wall system. For example, the entry guide 320 may include a high side fitting 330, a low side fitting 332, a block 334, and a stem 336, which are configured to attach to the receiving portion 304 only. Likewise, the cover 302 may be removed from the receiving portion 304 after the retractable wall system has been installed. This severability feature allows weight bars to be installed in the primary receiving channel 316 of a horizontal track of a previously erected retractable wall system. It also allows for cabling (e.g., structural, control, or electric cable) to be run through the secondary receiving channel 338 after the retractable wall structure (or awning) has been assembled. Moreover, sound proofing material may be placed inside the track after the retractable wall structure (or awning) has been assembled. The severability feature may improve the constructability of the system, as well as enhance worker safety because handling a track with preloaded weight bars is significantly heavier than handling an empty horizontal track.

Referring to FIG. 2, in one embodiment of the retractable wall system 12 one end of the tube (40, 40′) receives a motor assembly 28. A portion of the motor assembly may be secured to the bracket 90. The other end of the tube may receive an idler 56. The idler may include a ring of ball bearings that may be disposed on the end cap pin 54. In another embodiment, the idler may be spring loaded. In yet another embodiment the idler may be replaced with a “Chinese spring,” which stores energy as the retractable wall is lowered and releases stored energy as the retractable wall is raised. The energy released by these devices may assist in retracting the wall. An energy storage device (e.g., a spring loaded idler or “Chinese spring”) may be used in combination with a manual gearbox on the one end of the tube, in place of the electric motor assembly. Alternatively, an energy storage device may be used in combination with a chain drive mechanism on one end of the tube, instead of the electric motor assembly.

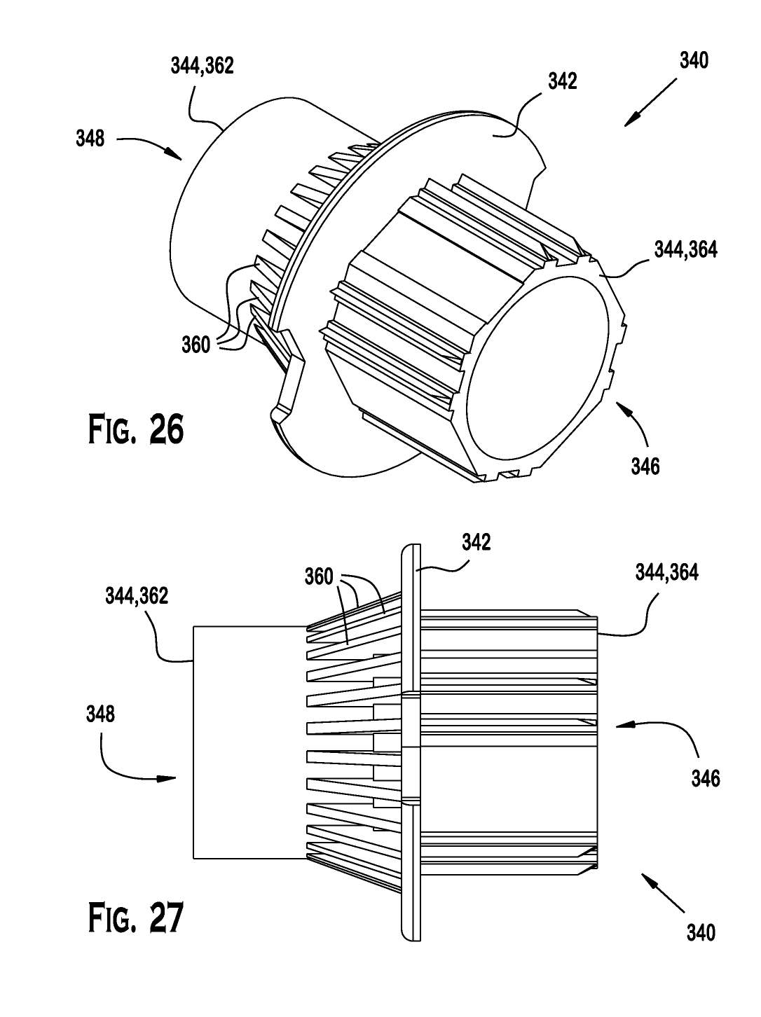

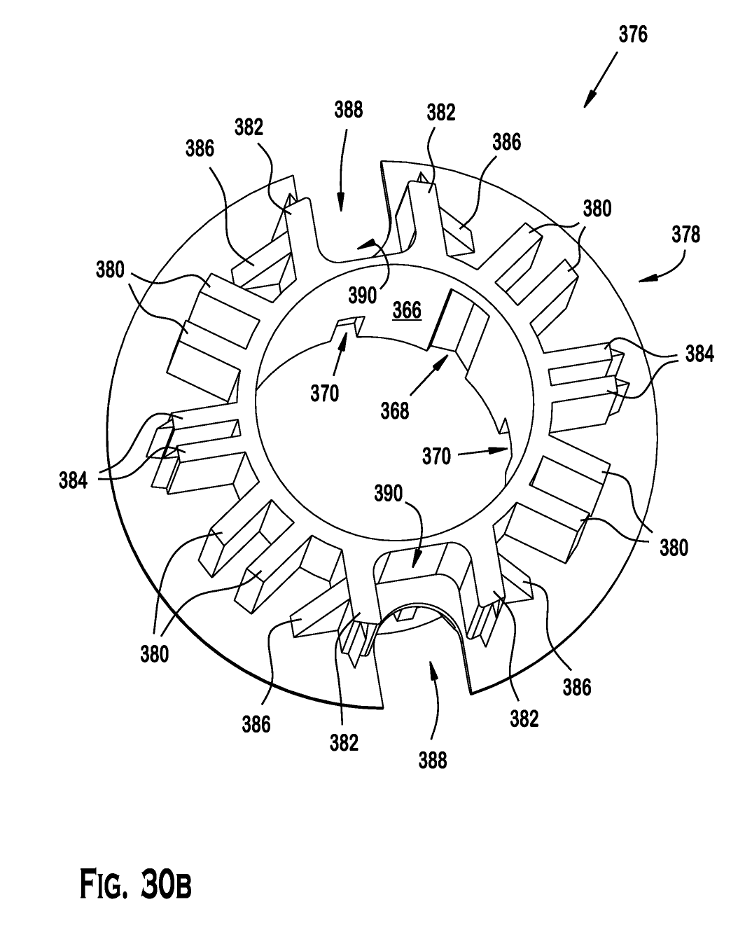

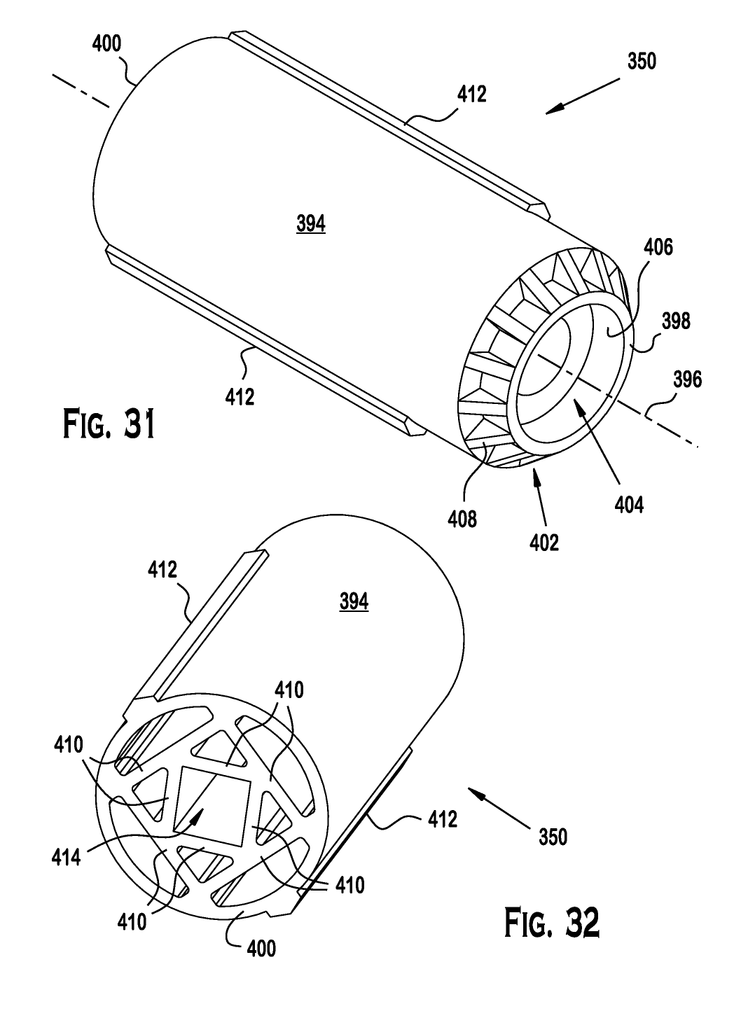

Referring to FIGS. 26-27, an adaptor flange 340 may be used to connect a retractable wall system (FIG. 2) tube 40 to the end caps 46, 50. The adaptor flange 340 may have a flange 342 disposed between two working end portions 344. For example, one working end portion 346 of the adaptor flange may be configured and dimensioned to mate with the tube. By contrast, the other end 348 of the adaptor flange may be configured and dimensioned to mate with a customized insert 350 (FIG. 31 and FIG. 32) which in turn may be adapted to connect to a gear box, drive chain, or mounted on an end cap pin or like bracket.

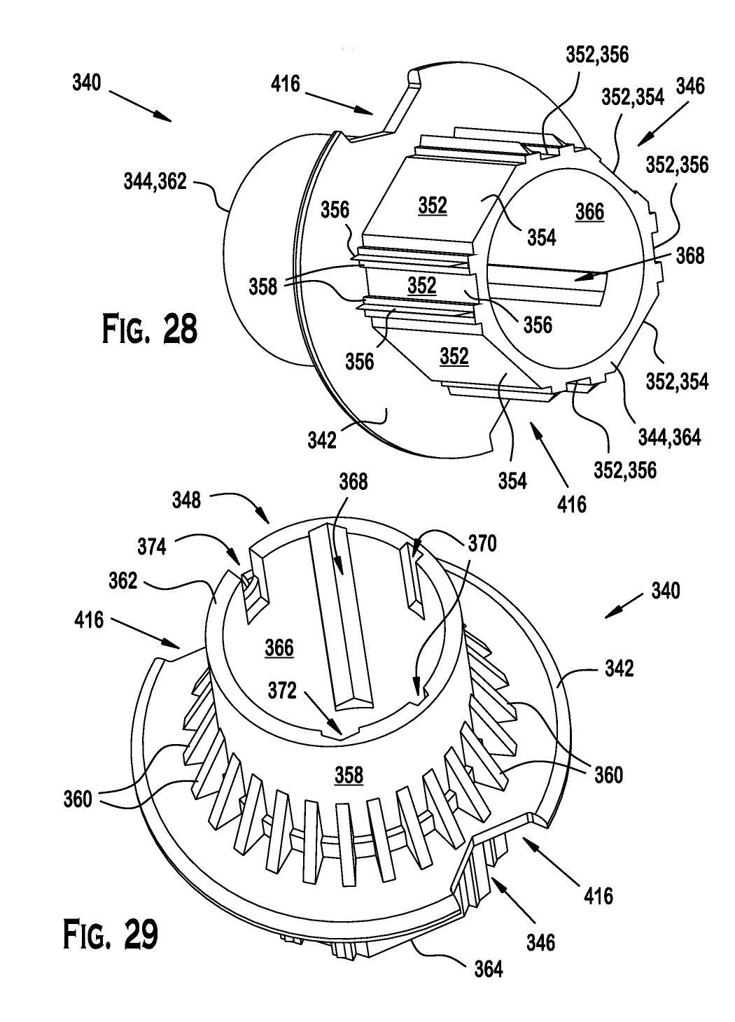

Referring to FIG. 28, the tube mating portion 346 may include one or more faces 352 that interlock with the internal features of the tube. For example, the one or more faces 352 of the tube mating portion 346 may be configured and dimensioned to form a press fit plug with the tube. For instance, interior wall segments or structural members 78 (FIG. 9) of the tube may receive and retain the press fit plug. The press fit plug may include four drive faces 354 and four rail faces 356. In one embodiment, a rail face 356 may include a base 358 and at a fin 360. Although the embodiment of the tube mating portion shown in FIG. 28 has an axis of symmetry, any configuration of plug features and fasteners may be used to connect with the tube end, provided the tube mating portion 346 is securely connected to the tube, rotation of the flange 342 turns the tube about an axis, and the structure can readily withstand the torque necessary to rotate the tube.

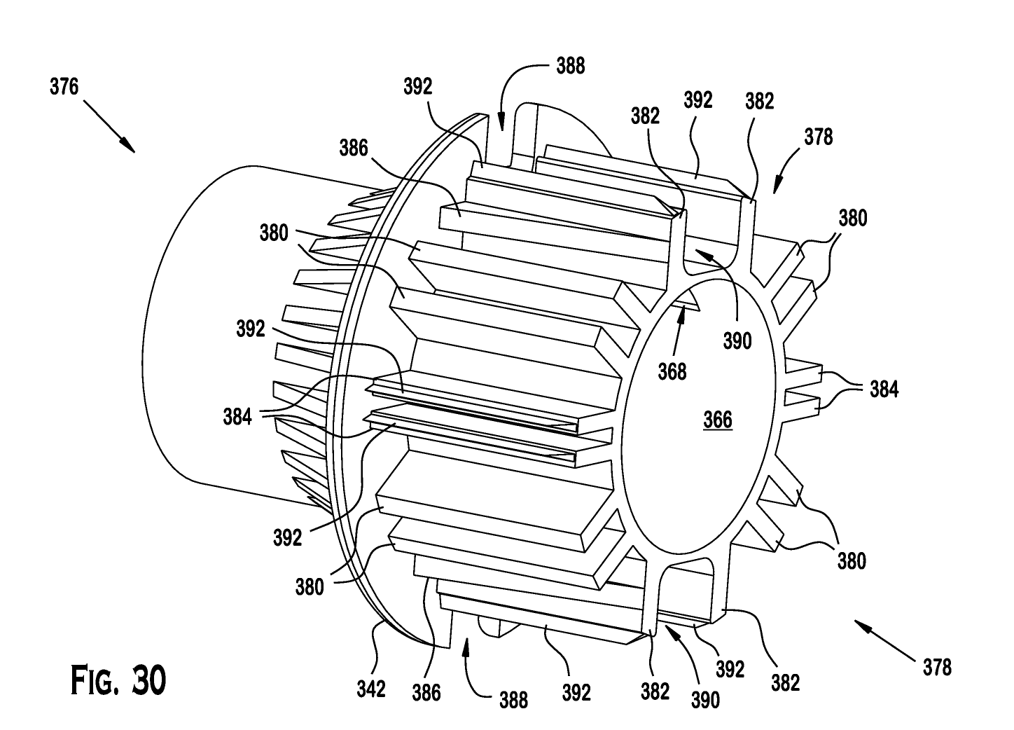

Referring to FIG. 29, the insert mating portion 348 may include a tube member 358 that is configured and dimensioned to mate, for example, with an idler, a spring loaded idler, an electric motor assembly, or a “Chinese spring.” Additionally, the hollow, tube member 358 may be configured and dimensioned to mate with the reversible insert of FIG. 31. In the embodiment shown in FIG. 29, the hollow, tube member 358 is circular cylindrical, however, a cylinder of any shape may be used provided that the tube member is adapted to cooperate with a drive mechanism (or hinge joint) that may be connected to (or cooperate with) an end cap. The outer surface of the hollow tube member 358 further may include structural elements 360 that reinforce the flange-tube member interface against sheering forces. The structural members 360 may include a plurality of reinforcing members. One (or more) of the reinforcing members 360 may form a buttress between the tube member 358 and the flange 342.

The adaptor flange 340 may have a leading end 362, a trailing end 364, and an internal side wall 366 extending from the leading end to the trailing end. The internal side wall may define a passage through the adaptor flange 340. The internal side wall 366 may include one or more grooves. A groove 368 may extend from the leading end 362 to an interior location on the internal side wall 366. Another groove(s) 370 may have a square cut. Yet another groove 372 may be spaced from the leading end groove 368 and the square cut groove(s) 370 on the side wall. The square cut groove(s) 370 may be configured and dimensioned to receive a raised key on the crown of an electrical motor assembly or similar accessory. For instance, the one or another square cut groove(s) 370 may be configured to receive one or more raised keys on the head of a Chinese spring. Additionally, the leading end groove(s) 368, 372 may be configured and dimensioned to receive a radial projection on the reversible insert 350 (FIGS. 31-32). A slot or opening on the groove 374 may extend through the side wall to provide a fastener attachment site for securing a fastener to the adaptor flange 340 and the flange accessory (e.g., crown of electrical motor, Chinese spring, and reversible insert 350).

FIGS. 30 and 30b show another embodiment of an adaptor flange 376 of the present invention. The adaptor flange 376 may be configured and dimensioned to mate with a conventional awning tube or a galvanized steel roller tube. In this embodiment, the tube mating portion 378 may include three different connectors for securing the tube mating portion 378 within a conventional tube. For instance, the connectors may include a plurality of blocks 380, primary rails 382 and secondary rails 384, as well as a wing that forms a buttress between the flange 342 and the primary rails 380. The distribution of the connectors may be uniform or may form a pattern around the exterior side wall of the tube mating portion 378. For example, pairs of like connectors may be disposed about the circumference of the tube mating portion at a radial interval of approximately 180 degrees. In one configuration, one primary rail 380 may be disposed next to each lateral edge of the respective flange cutouts 388. The primary rails 380 may define a passage 390 behind the flange cutout 380 that allows a loop of awning material to be slipped into a tube pocket (see FIG. 33). The primary rails 380 may be reinforced with a wing structure 386 that buttresses the primary rail with respect to the flange. A pair of blocks 380 may be disposed on either side of the primary rails 384 to provide additional structural support for the inner wall of the tube. A pair of secondary rails 384 may be disposed between two pairs of blocks 380. Each rail may include a fin 392 that projects beyond an imaginary circumference defined by the end surface of the rail base and blocks so as to provide for a tighter, more secure press fit to the tube.

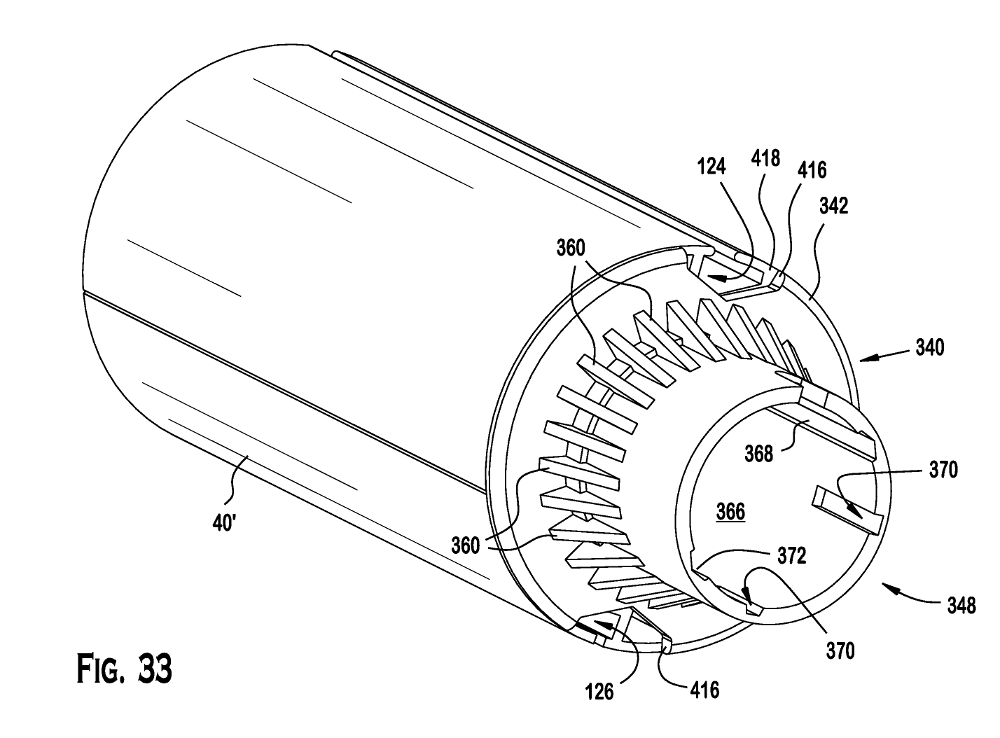

FIG. 31 shows an exemplary embodiment of an insert 350. The insert 350 may include a body 394 formed from a cylindrical member. The cylindrical member may have a central axis 396 as well as a proximal end 398 and a distal end 340. The cylindrical member may be circular cylindrical. The cylindrical member may be tapered such that the diameter at one end of the member is larger than at the opposite end. The insert 350 may include a nose 402 adjacent to the proximal end 398. The nose 402 may include a bearing receiving port 404. The bearing receiving port 404 may include an annular wall 406 that defines a circular cylindrical port which may be configured and dimensioned to receive a ring of ball bearings. One or more reinforcing members 408 may connect the circumference of the annular wall 406 to the body 394 in order to buttress the nose 402 against sheering forces. The distal end 400 of the body 394 may include internal structures 410 that are adapted to receive the driver of a gearbox or a pulley chain drive. The insert may further include one or more radial projections 412 on the body. Each radial projection 412 may be configured and dimensioned to mate with a respective groove 368, 372 on the internal side wall 366 of either adaptor flange described above. Additionally, the one or more radial projections 412 may be located on the body 394 such that: (1) the nose 402 protrudes from the adaptor flange when the distal end 400 is inserted into the adaptor flange; and (2) the gearbox or drive chain receiving end 398 are flush with the distal end 400 of the insert when the nose 402 is inserted in to the adaptor flange. (e.g., FIG. 34). This spacing differential provides the necessary space for the gearbox or drive chain assembly in the end cap when the distal end of the insert is disposed within the flange. Similarly, the spacing differential provides the necessary space for the bearing ring cage to mount on the end cap stub 54 (or similar structure).

FIG. 32 shows the distal end 400 of the insert of FIG. 31. The distal end 400 of the inset 394 may include a plurality of structural reinforcing members 410 inside the insert. The orientation of the structural reinforcing members 410 may be designed to make the insert 394 more resistant to bending moments and sheering forces. The internal structural reinforcing members may provide added rigidity to the insert 394 so as to prevent bending and cracking of the insert under the static and dynamic loads attendant to mounting and operating the tube-flange-insert assembly. Additionally, the structural reinforcing members 410 may define a driver receptacle 414 for receiving the driver of a manually operated gear box or the driver of a pull chain mechanism.

As shown in FIG. 33, the tube mating portion 352 of the adaptor flange 340 may be inserted into the tube 40 until the flange 342 contacts the end 418 of the tube. The adaptor flange may be oriented such that the flange cutouts 416 are generally aligned with the pocket receptacles 124, 126. Depending on the application, an insert 350, motor 42, idler or “Chinese spring” may be placed into the insert receiving end (or insert mating end) 348 and interlocked with the appropriate grooves 368, 372 on the internal sidewall 366.

FIG. 34 and FIG. 34b show a rear and front perspective view, respectively, of two adaptor flange embodiments 340, 376 with the insert 350 of FIGS. 31-32.

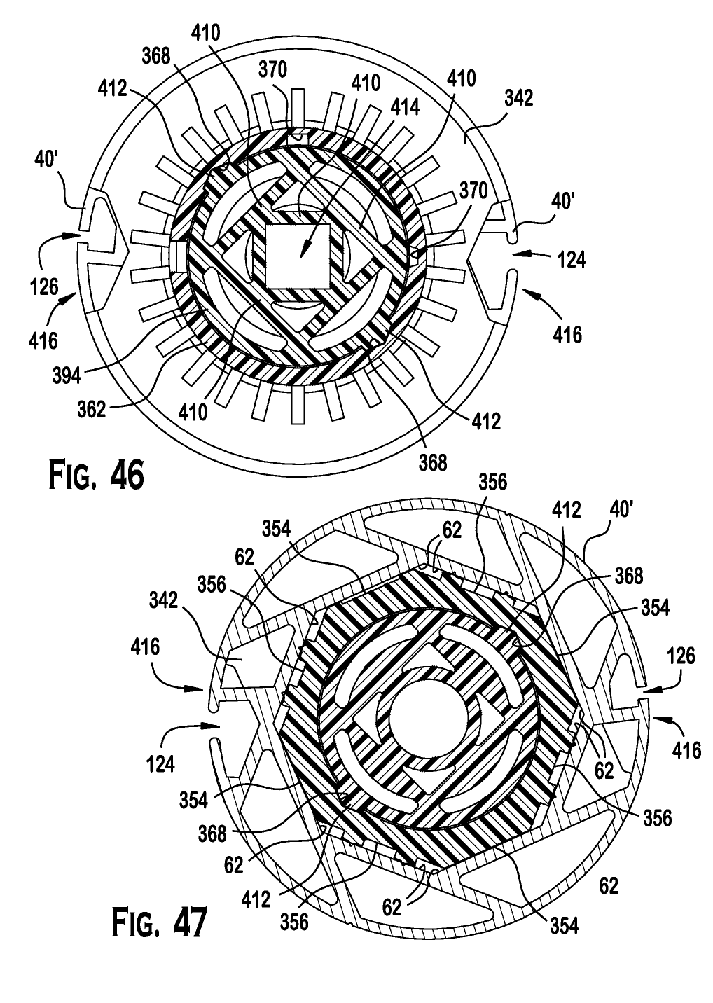

Referring to FIG. 34, one adaptor flange 340 and insert 350 assembly configuration 542 depicts the insert 350 after being placed within the adaptor flange 340 from the insert mating portion 348 with the proximal end 398 of the insert 350 facing inward. In this configuration 542, the bearing receiving port 404 is not available for use at the working end 344 of the insert mating portion 348 of the adaptor flange 340. Instead, the distal end 400 of the insert 350 is available for use at the working end 344 of the insert mating portion 348 of the adaptor flange 340. As shown in FIG. 34B, this configuration of the adaptor flange 340 and insert 350 assembly 542 provides working access to the driver receptacle 414 on the distal end of the insert 400. The radial projection(s) 412 of the insert 350 are disposed and interlocked within the leading end groove(s) 368 of the adaptor flange 340. The distal end 400 of the insert 350 may be flush with the working end portion 344 of the adaptor flange 340. In this configuration, the driver of a manual gearbox may be inserted into the driver receptacle 414 to rotate the adaptor flange 340 and insert 350 assembly 542. Referring to FIG. 46, internal structures 410 of the insert 350 strengthen (or reinforce) the assembly 542 from sheering forces and bending moments associated with a tube connected to the tube mating portion 346 of the adaptor flange 340. In another operable configuration of the adaptor flange 340 in which the insert 350 is not used, one or more square cut grooves 370 may be used to interlock with an electric motor or spring assembly. Referring to FIG. 47, a rail face(s) 354 and a drive face(s) 356 of the adaptor flange 340 may bear on an interior surface(s) 62 of the tube so as to provide a mechanism for transferring rotational movement from the driver of a manual gearbox or other device.

Referring to FIG. 34, another adaptor flange 340 and insert 350 assembly configuration 544, depicts the insert 350 after being placed within the adaptor flange 340 from the insert mating portion 348 with the distal end 400 of the insert 350 facing inward. In this configuration 544, the bearing receiving port 404 is available for use at the working end 344 of the insert mating portion 348 of the adaptor flange 340. The proximal end of the insert 398 may project from the working end 344 of the insert mating portion 348. The proximal end of the insert 398 may project from the working end 344 of the insert mating portion 348 such that a ring bearing placed in the bearing receiving port 404 may be received onto a cylindrical stub 54 of an end-cap wall. As shown in FIG. 34B, this configuration of the adaptor flange 340 and insert 350 assembly 544 provides working access to the bearing receiving port 404 on the proximal end of the insert 398. The radial projection(s) 412 of the insert 350 are disposed and interlocked within the leading end groove(s) 368 of the adaptor flange 340. In this configuration 544, a bearing ring cage may be placed in the bearing receiving port 404, which may be disposed onto a cylindrical stub 54 of an end-cap wall.

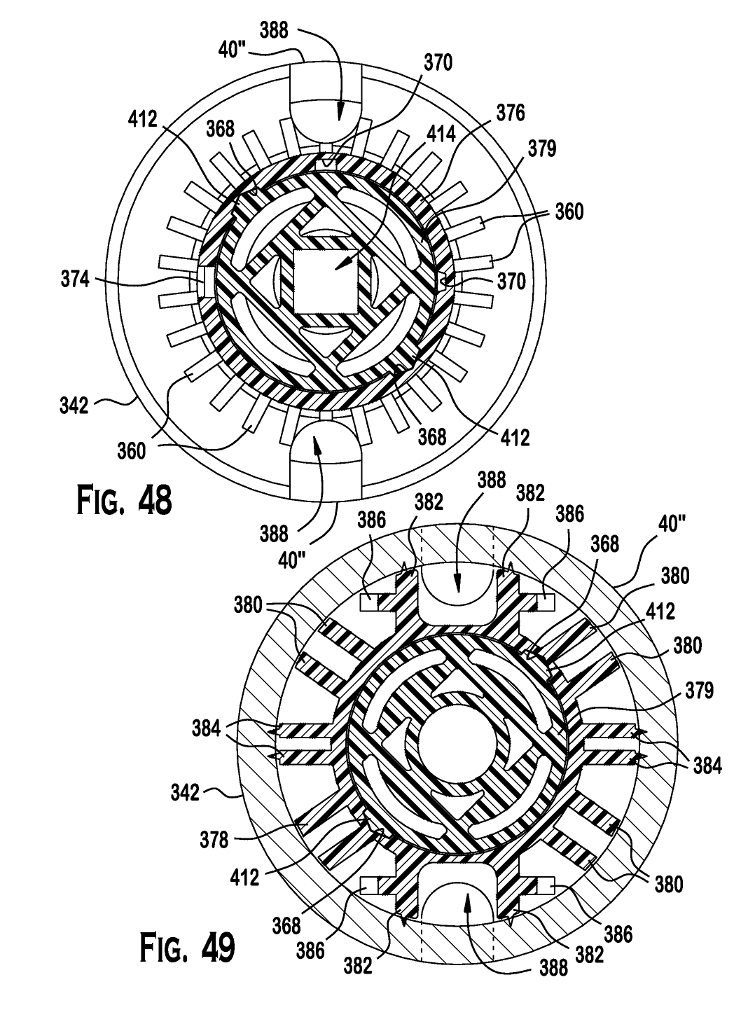

Referring to FIG. 34, another adaptor flange 376 and insert 350 assembly configuration 546 depicts the insert 350 after being placed within the adaptor flange 376 from the insert mating portion 348 with the proximal end 398 of the insert 350 facing inward. In this configuration 546, the bearing receiving port 404 is not available for use at the working end 344 of the insert mating portion 348 of the adaptor flange 376. Instead, the distal end 400 of the insert 350 is available for use at the working end 344 of the insert mating portion 348 of the adaptor flange 376. As shown in FIG. 34B, this configuration of the adaptor flange 376 and insert 350 assembly 546 provides working access to the driver receptacle 414 on the distal end of the insert 400. The radial projection(s) 412 of the insert 350 are disposed and interlocked within the leading end groove(s) 368 of the adaptor flange 376. The distal end 400 of the insert 350 may be flush with the working end portion 344 of the adaptor flange 376. In this configuration, the driver of a manual gearbox may be inserted into the driver receptacle 414 to rotate the adaptor flange 376 and insert 350 assembly 546. Referring to FIG. 48, internal structures 410 of the insert 350 strengthen (or reinforce) the assembly 546 from sheering forces and bending moments associated with a conventional tube connected to the tube mating portion 346 of the adaptor flange 376. In another operable configuration of the adaptor flange 376 in which the insert 350 is not used, one or more square cut grooves 370 may be used to interlock with an electric motor or spring assembly. Referring to FIG. 49, block(s) 380, primary rails 382, and secondary rail(s) 384 may bear on an interior surface(s) 62 of the conventional tube 40″ so as to provide a mechanism for transferring rotational movement from the driver of a manual gearbox or other device.

Referring to FIG. 34, another adaptor flange 376 and insert 350 assembly configuration 548, depicts the insert 350 after being placed within the adaptor flange 376 from the insert mating portion 348 with the distal end 400 of the insert 350 facing inward. In this configuration 548, the bearing receiving port 404 is available for use at the working end 344 of the insert mating portion 348 of the adaptor flange 376. The proximal end of the insert 398 may project from the working end 344 of the insert mating portion 348. The proximal end of the insert 398 may project from the working end 344 of the insert mating portion 348 such that a ring bearing placed in the bearing receiving port 404 may be received onto a cylindrical stub 54 of an end-cap wall. As shown in FIG. 34B, this configuration of the adaptor flange 376 and insert 350 assembly 548 provides working access to the bearing receiving port 404 on the proximal end of the insert 398. The radial projection(s) 412 of the insert 350 are disposed and interlocked within the leading end groove(s) 368 of the adaptor flange 376. In this configuration 548, a bearing ring cage may be placed in the bearing receiving port 404, which may be disposed onto a cylindrical stub 54 of an end-cap wall.

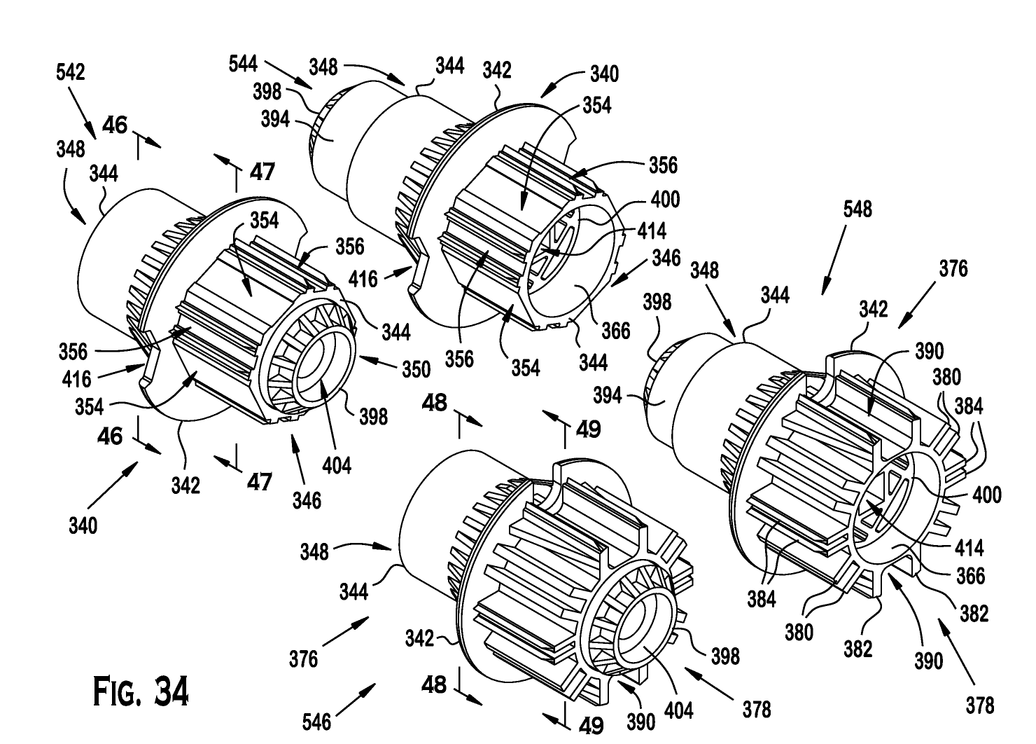

FIG. 35 shows another embodiment of an end piece 420 that may be used with a horizontal track 24 of the retractable awning system 12. The end piece 420 may include an upper guide plug 422 which is configured and dimensioned to form a press fit with the secondary accessory receiving channel 338 of the track 300. The end piece further may include a lower guide plug 424 which is configured and dimensioned to form a press fit with the primary accessory receiving channel 316 in the track 300. As described above, the end piece may include two planar members 426 and a slot 428 between the planar members 428 for receiving flexible barrier material 26. The planar members 426 may include fastener holes 430 for securing a flexible barrier material in the slot 428 between the planar members to form a flexible barrier material guide for a retractable wall system 12.

FIG. 36 shows the end piece 420 from a rear perspective view. Visible from this view are fins 430 on the upper guide plug 422 and the lower guide plug 424 for helping to create a tight press fit between the plugs and their respective accessory channels. Additionally, opposing surfaces 432, 434 on the upper guide plug and the lower guide plug, respectively, may define a crevice 436 for receiving the track wall 438 (FIG. 24 and FIG. 25) that separates the primary accessory receiving channel 316 and the secondary accessory receiving channel 338. The end piece may further include a bumper 440. The bumper 440 may generally correspond to the profile of a portion of the track 300 that is situated next to the end piece 420.

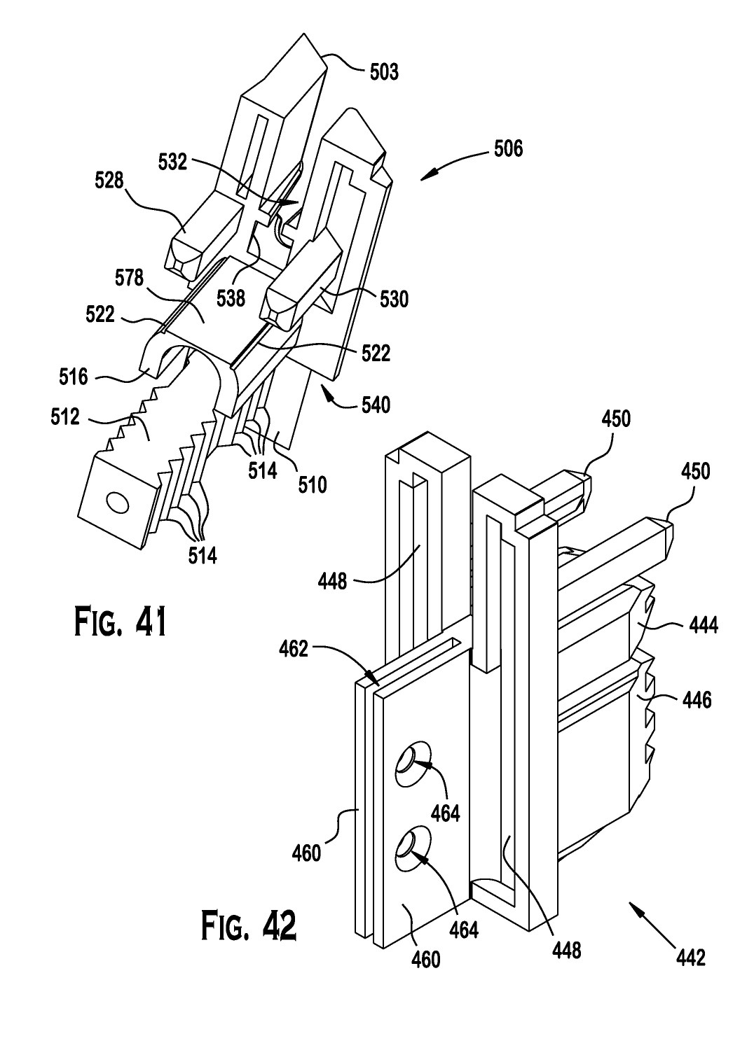

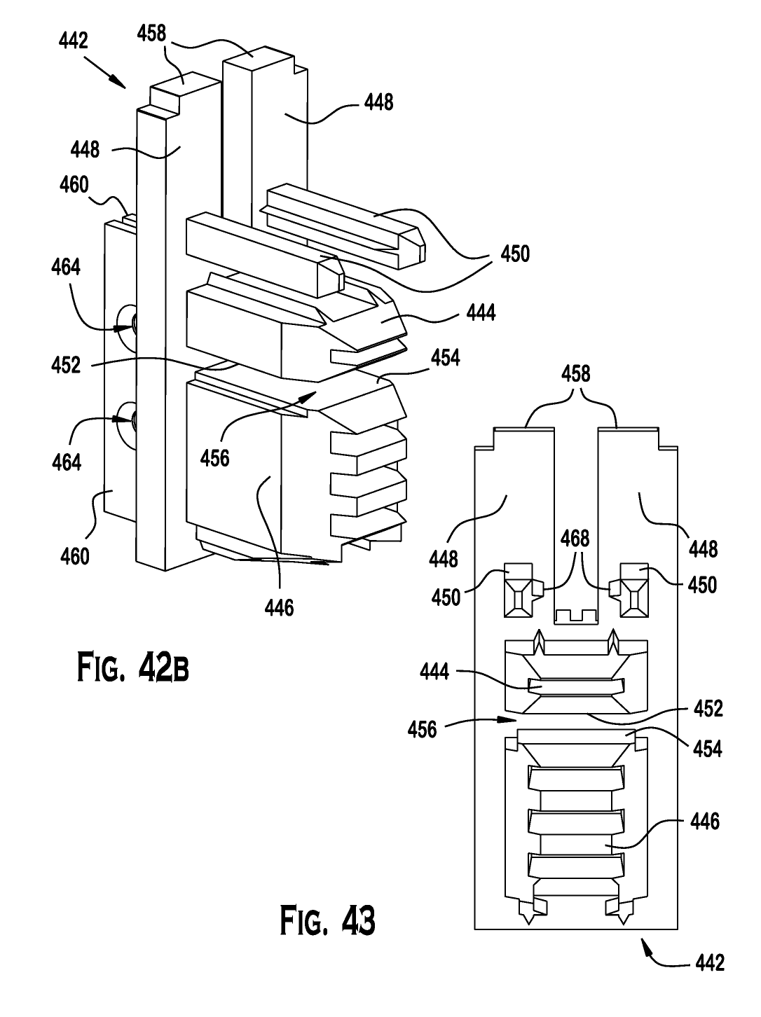

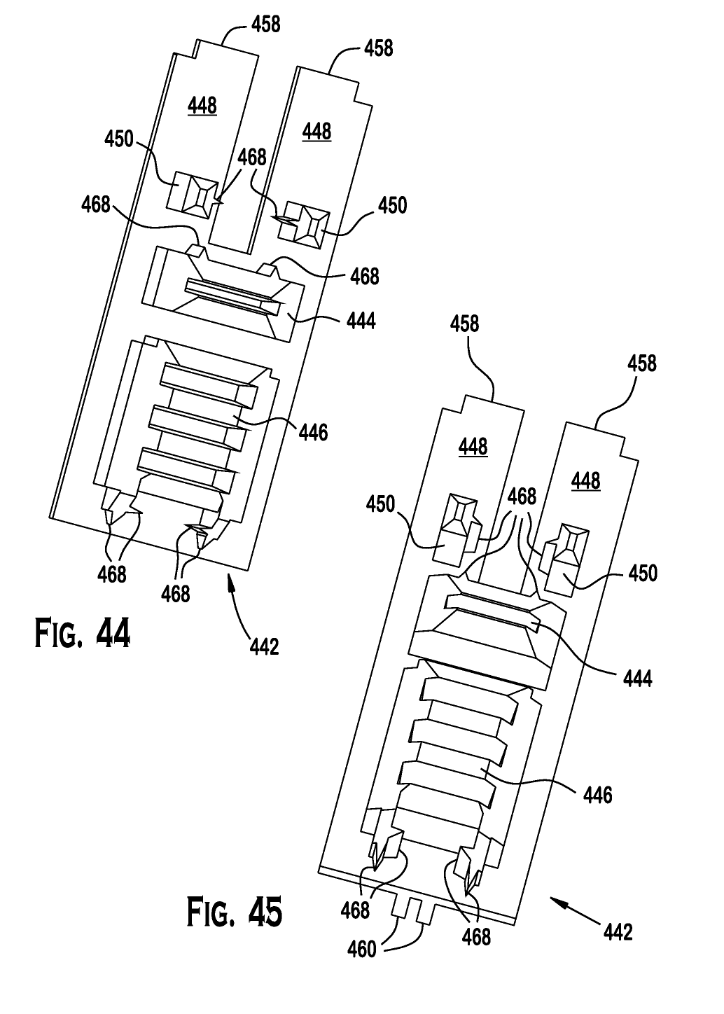

FIGS. 42-45 show yet another embodiment of an end piece 442. FIG. 42 and FIG. 42b show an end piece 442 which may be used with the track 300 of FIG. 24 and FIG. 25.

The end piece 442 may include an upper guide plug 444 which may be configured and dimensioned to form a press fit with the secondary accessory receiving channel 338 of the track 300. The lower guide plug 446 may be configured and dimensioned to form a press fit with the primary accessory receiving channel 316 in the track 300. The end piece further may include a plate 448 and two prongs 450 extending from the plate. Furthermore, the end piece 442 may include opposing surfaces 452, 454 on the upper guide plug 444 and the lower guide plug 446, respectively, may define a crevice 456 for receiving the track wall 438 (FIG. 24 and FIG. 25), which may separate the primary accessory receiving channel 316 and the secondary accessory receiving channel 338. The end piece 442 may further include a bumper 458. The bumper 458 may generally correspond to the profile of a portion of the track 300 that is situated next to the end piece 442. Also, the end piece 442 may include two planar members 460 and a slot 462 between the planar members 460 for receiving flexible barrier material 26. The planar members 460 may include fastener holes 464 for securing flexible barrier material in the slot 462 to form a flexible barrier material guide for the retractable wall system 12.

Each prong 450 may be disposed on one side of the fabric receiving slot 462. Referring to FIG. 24 and FIG. 25, the prongs 450 may be configured and dimensioned to form a press fit with walls of the internal anchoring cavity 466 on the receiving portion 304 of the track 300. This may allow the cover 302 of the track 300 to be snapped into place after the end piece 442 has been installed into the receiving portion 304. This may have particular utility in allowing the retractable wall system 12 to be erected initially with receiving portion 304 only. Thereafter weight bars may be loaded into the primary accessory receiving channel 318. Then the cover 302 may be connected to the receiving portion 304 to complete the horizontal bar assembly.

FIGS. 43-45 show the end piece of FIG. 42 from various rear perspective views. Visible from these views are fins 468 on the upper guide plug 444 and lower plug 446 for helping to create a tight press fit between the plugs and their respective accessory channels. Fins 468 on the lower guide plug 446 may be positioned to form a press fit with the walls which form the tertiary accessory receiving channel 98, 224 (see e.g., FIGS. 10, 11 and 15). In this embodiment, the fins 468 are positioned to form a press fit with the receiving portion 304 only. Also, the fins 468 may be hard and sharp enough to score the track 300 to further provide a secure and tight fit. The bumper 458 may conform to the square cut of the two piece track 300 shown in FIG. 24 and FIG. 25.

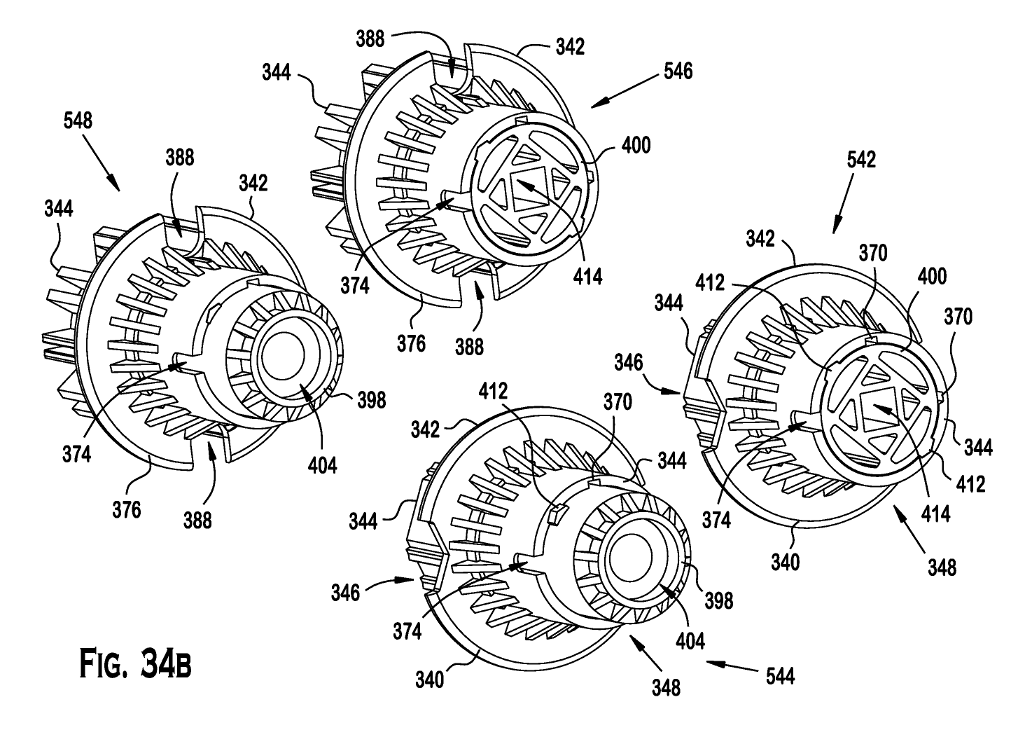

FIG. 37 shows another embodiment of an entry guide 470. As previously described in connection with FIGS. 14 and 15, an entry guide 52, 470 may be inserted into the top end of the right side vertical track 22. A mirror image of the entry guide may be used for the left side vertical track 20. The entry guide 470 may be configured and dimensioned to create a press fit with the track 22 and stem 176 of the associated end cap 50. The entry guide may include an upper surface 472 and a lower surface 474, which is configured and dimensioned to abut the track when fully inserted into the track. The entry guide 470 further may include a stem 476, which projects from the lower surface 474 of the entry guide. The stem 476 may possess serrations (or teeth) 478 on its lateral sides. The stem 478 may be configured and dimensioned to form a press fit with the retention wall 312 and guide wall 314 in the primary accessory receiving channel 316 (FIG. 24). The entry guide 470 may further include a block 480 that is disposed adjacent to the stem 478 on the lower surface 474 of the entry guide. The block 480 may include a central landing 482 bounded by a pair of tapered risers 484 and treads 486 on one or more lateral faces of the block. The block 480 may further include a side wall 488 which extends from the rear surface of the block to an interior of the block. The side wall 488 may extend from the rear surface of the block to the upper surface 472 of the entry guide. The side wall 488 may form a through bore 490 that extends from the rear surface of the block to the upper surface of the entry guide. The through bore may have a central axis and a cross-sectional area perpendicular to the central axis. The cross-sectional area may be uniform or may vary through the entry guide. The through bore 490 may be sized for passage of an electrical motor cable or a steel tensioning cable. The size of the through bore 490 may be selected for the particular application. The block may be configured and dimensioned to form a press fit with the secondary accessory receiving channel 338. The entry guide 470 further may include a high side fitting 492 and a low side fitting 494 which may be configured and dimensioned to form a press fit with the upper channels of the track.

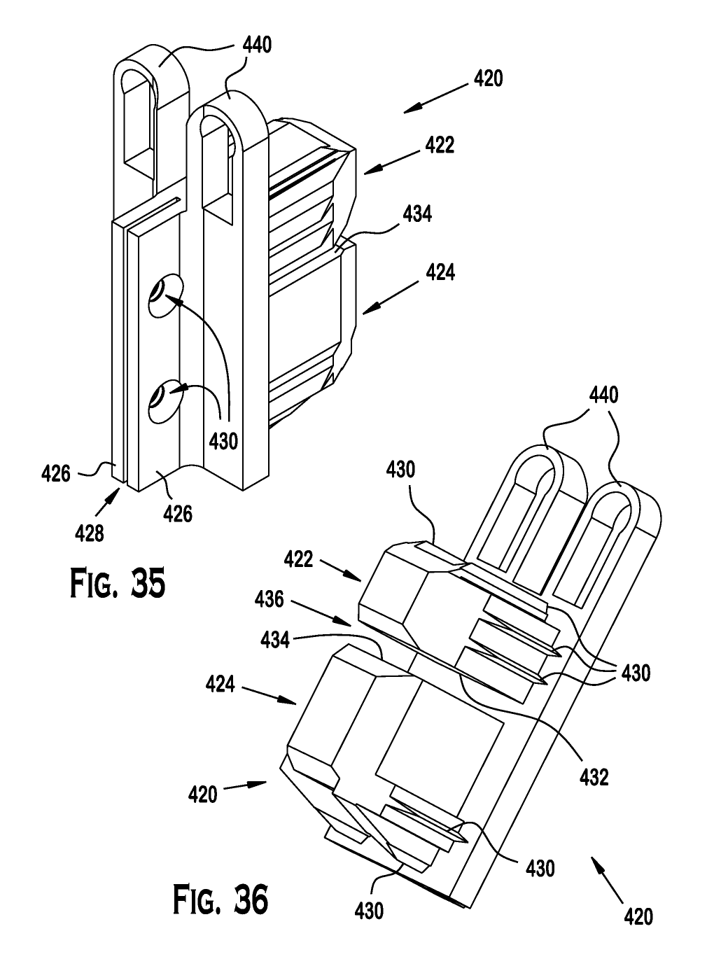

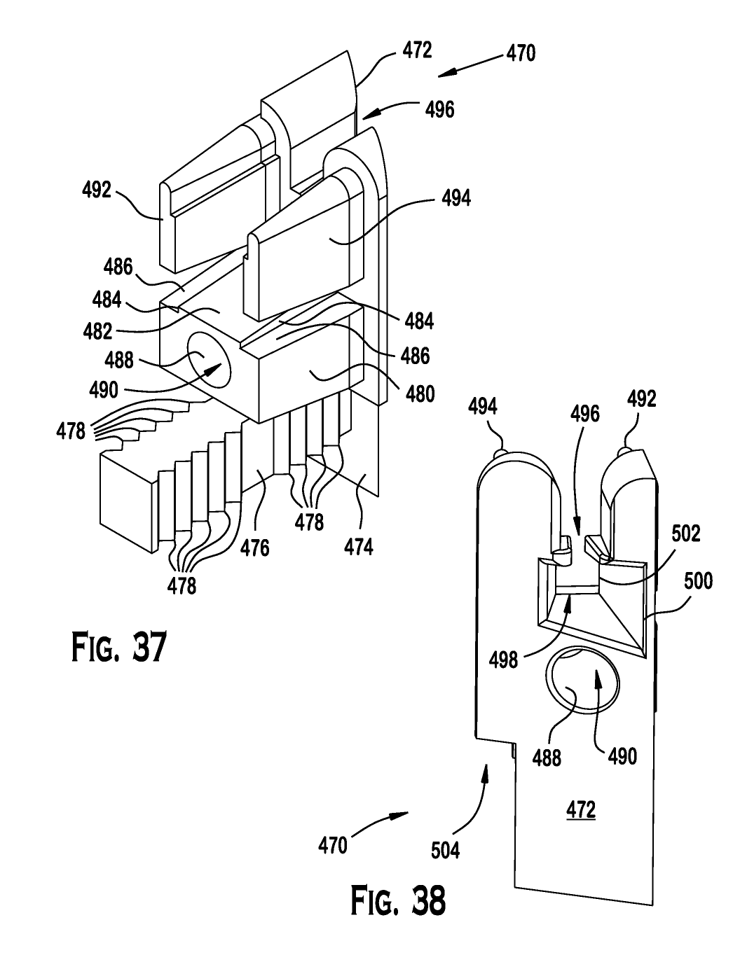

Referring to FIG. 38, one side of the entry guide may be taller than a second side, and thus the upper surface 472 of the entry guide may form a diagonal surface that slopes from the high side to the low side of the entry guide. The entry guide may include a feed slot 496 and guide channel 498 disposed between the high side fitting 492 and the low side fitting 494. The feed slot 496 and guide channel 498 may taper from a wider opening 500 at the upper surface to a more narrow opening 502 at the lower surface of the entry guide. The through bore 490 is also visible in FIG. 38, along with the cut out 504 for the end cap stem.

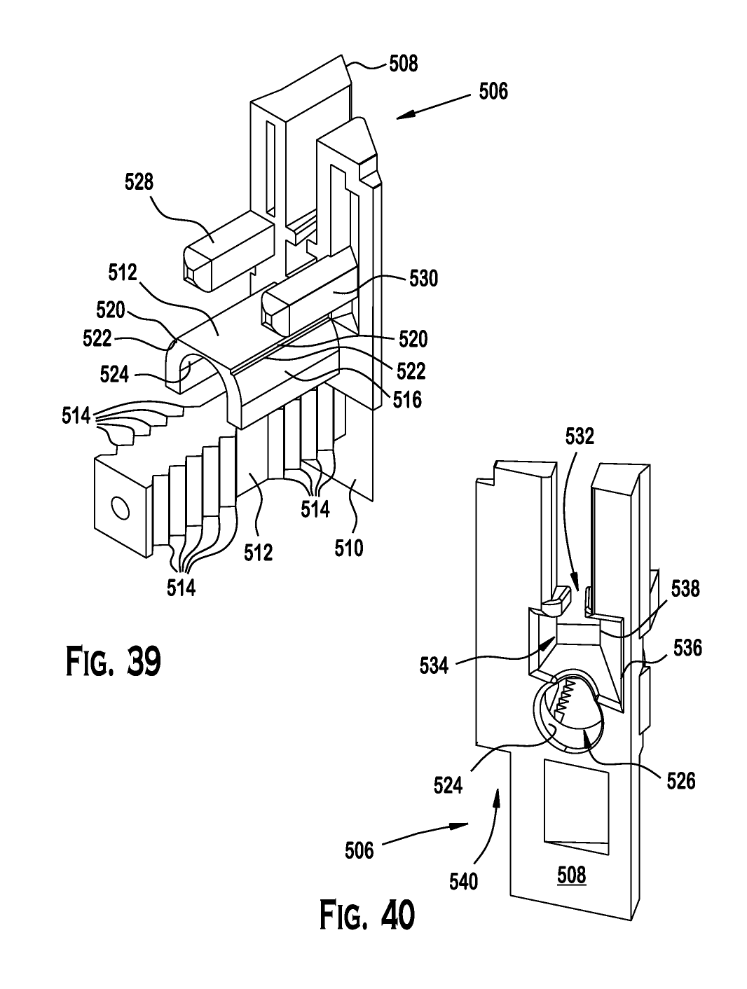

FIGS. 39-41 show yet another embodiment of an entry guide 506 (or feeder clip 52). As previously described in connection with FIGS. 14 and 15 above, an entry guide 506 may be inserted into the top end of the right side vertical track. A mirror image of the entry guide 506 may be used for the left side vertical track. The entry guide 506 may be configured and dimensioned to create a press fit with the track 300 and stem of the associated end cap. The entry guide 506 may include an upper surface 508 and a lower surface 510, which is configured and dimensioned to abut the track when fully inserted into the track. The entry guide 506 may further include a stem 512 which projects from the lower surface 510 of the entry guide. The stem 512 may possess serrations (or teeth) 514 on its lateral sides. The stem 512 may be configured and dimensioned to form a press fit with the retention wall 312 and guide wall 314 in the primary accessory receiving channel 316 (FIG. 24). The entry guide 506 further may include a block 516 that is disposed adjacent to the stem 512 on the lower surface 510 of the entry guide. The block 516 may include a central landing 518 bounded by a pair of tapered risers 520 and treads 522 on one or more lateral faces of the block. The block may be configured and dimensioned to form a press fit with the secondary accessory receiving channel 339.

As shown in FIGS. 39-41, the block 516 of this entry guide may include a side wall 524 as described in connection with the embodiment of FIG. 37 and FIG. 38. Accordingly, a side wall may extend from the rear surface of the block to the upper surface of the entry guide. The side wall may form a through bore 526 that extends from the rear surface of the block to the upper surface of the entry guide. The through bore 526 may have a central axis and a cross-sectional area perpendicular to the central axis. The cross-sectional area may be uniform or may vary through the entry guide. The through bore may be sized for passage of an electrical motor cable or a steel tensioning cable. The size of the through bore may be selected for the particular application.

Referring to FIG. 39, the entry guide 506 may include a high side fitting 528 and a low side fitting 530 which may be configured and dimensioned to form a press fit with the walls of the internal anchoring cavity 466 on the receiving portion 304 of the track 300 (FIGS. 24 and 25). Such a configuration allows the cover 302 of the track 300 to be snapped into place after the end piece has been installed into the receiving portion 304. This may have particular utility in allowing the retractable wall system to be erected initially with the receiving portion 304 only. Thereafter cables may be strung through the bore in the block and the secondary accessory channel 339 of the track 300. The cover may be connected to the receiving portion 304 after the cable has been strung to complete the vertical track assembly.

Referring to FIG. 40, one side of the entry guide 506 may be taller than a second side, and thus the upper surface of the entry guide 506 may form a diagonal surface that slopes from the high side to the low side of the entry guide. The entry guide 506 may include a feed slot 532 and guide channel 534 disposed between the high side fitting 528 and low side fittings. The feed slot 532 and guide channel 534 may taper from a wider opening 536 at the upper surface to a more narrow opening 538 at the lower surface of the entry guide. Also, visible in FIG. 40 is the cutout 540 for the end cap stem.

While it has been illustrated and described what at present are considered to be preferred embodiments of the present invention, it will be understood by those skilled in the art that various changes and modifications may be made, and equivalents may be substituted for elements thereof without departing from the true scope of the invention. Additionally, features and/or elements from any embodiment may be used singly or in combination with other embodiments. Therefore, it is intended that this invention not be limited to the particular embodiments disclosed herein, but that the invention include all embodiments falling within the scope and the spirit of the present invention.

1-28. (canceled)

29. A track for a retractable wall system comprising:
an elongated member having a first cross-sectional profile which comprises
a front wall,
a rear wall spaced from the front wall,
a bottom wall connecting the front wall and the rear wall,
a first top wall adjacent the front wall,
a second top wall adjacent the rear wall, and
an open channel disposed between the first top wall and the second top wall, the open channel comprising a channel profile which comprises
a first side wall extending from the first top wall toward the bottom wall,
a second side wall extending from the second top wall toward the bottom wall,
a first ledge adjacent to the first side wall, the first ledge extending toward the second side wall, and
a second ledge extending from the second side wall toward the first ledge,
a slot disposed between the first ledge and the second ledge,
a third side wall abutting against the first side wall, the third side wall being spaced from the second side wall, and
a conduit disposed between the second side wall and the third side wall, the conduit being connected to the open channel via the slot.

30. The track of claim 29, wherein the first cross-sectional profile further comprises a lateral wall that extends from the rear wall toward the front wall, and the conduit is formed by the first ledge, the second ledge, the second side wall, the third side wall, and the lateral wall.

31. The track of claim 30, wherein the third side wall extends from the lateral wall.

32. The track of claim 31, wherein the front wall is secured to the lateral wall by a first releasable connection.

33. The track of claim 32, wherein the first releasable connection comprises a first press fit connection.

34. The track of claim 33, wherein the bottom wall comprises a first detent situated adjacent to the front wall, the first detent being configured and dimensioned to mate with the front wall.

35. The track of claim 32, wherein the first cross-sectional profile further comprises an interior wall that extends from the rear wall toward the front wall.

36. The track of claim 35, wherein the front wall, the lateral wall, the first releasable connection, the rear wall, and the interior wall define a first interior channel.

37. The track of claim 36, wherein the front wall, the interior wall, the rear wall, and the bottom wall define a second interior channel.

38. The track of claim 37, wherein the front wall, the first top wall, the first side wall, the third side wall, and the lateral wall surround a third interior channel.

39. The track of claim 38, wherein the rear wall, the second top wall, the second side wall, the lateral wall, and the first releasable connection surround a fourth interior channel.

40. The track of claim 39, wherein the bottom wall comprises another open channel.

41. The track of claim 39, wherein the front wall is secured to the bottom wall by a second releasable connection.

42. The track of claim 41, wherein the second releasable connection comprises a second press fit connection.

43. The track of claim 42, wherein the bottom wall comprises a second detent situated adjacent to the front wall, the second detent being configured and dimensioned to mate with the front wall.

44. The track of claim 29, further comprising a weight bar disposed in the second interior channel.

45. The track of claim 29, wherein the elongated member comprises:
a first operable configuration such that in the first operable configuration the front wall is releasably connected to the lateral wall and the bottom wall, and the first side wall rests on the third side wall; and
a second operable configuration such that in the second configuration the front wall is disconnected to the lateral wall and the bottom wall, and the first side wall and the third side wall are separated from each other.

46. A retractable wall system comprising:
a tube which comprises a longitudinal axis;
a first track perpendicular to the longitudinal axis;
a second track opposite the first track;
a track of claim 1 disposed between the first track and the second track, the track of claim 1 further comprising
a first traveling guide disposed in the first track, and
a second traveling guide disposed in the second track; and
a flexible membrane barrier connected to the tube, the flexible membrane barrier comprising
a first side,
a second side, and
a third side,
wherein the first side of the flexible membrane barrier is disposed in the first track and secured to the first traveling guide, the second side is disposed in the second track and secured to the second traveling guide, and the third side is secured within the conduit of the track of claim 1.

47. The retractable wall system of claim 46, wherein the flexible membrane barrier further comprises a first edge portion adjacent the first side; the first traveling guide further comprises a first prong, a first planar member, a second planar member spaced from the first planar member, and a space defined between the first planar member and the second planar member; the first edge portion of the flexible membrane barrier being fixed in the space.

48. The retractable wall system of claim 47, wherein the first prong of the first traveling guide is positioned against the track of claim 1.
